(19) United States
(12) Patent Application Publication
(10) Pub. No.: US 2024/0309295 A1
(43) Pub. Date: Sep. 19, 2024

(54) COMPOSITIONS AND METHODS OF USE FOR MACHINE WAREWASHING, BOTTLE WASHING, AND PULP ANTIFOAMING APPLICATIONS

(71) Applicant: ECOLAB USA INC., Saint Paul, MN (US)

(72) Inventors: Victor Fuk-Pong Man, Saint Paul, MN (US); Clinton Hunt, JR., Saint Paul, MN (US); Gang Pu, Saint Paul, MN (US); Mark Schomers, Saint Paul, MN (US)

(21) Appl. No.: 18/605,977

(22) Filed: Mar. 15, 2024

Related U.S. Application Data
(60) Provisional application No. 63/490,892, filed on Mar. 17, 2023.

(51) Int. Cl. C11D 1/825; C11D 1/72; C11D 1/722; C11D 3/00; C11D 3/04; C11D 3/10; C11D 3/28; C11D 3/48; D21H 17/00; D21H 17/07; D21H 17/53; D21H 17/64; D21H 17/66; D21H 21/12

(52) U.S. Cl. CPC C11D 1/8255; C11D 3/0026; C11D 3/044; C11D 3/10; C11D 3/28; C11D 3/48; D21H 17/07; D21H 17/53; D21H 17/64; D21H 17/66; D21H 17/74; D21H 21/12; C11D 1/721; C11D 1/722

(57) ABSTRACT

Surfactant compositions and solid compositions with detersive combinations of surfactants are provided. Solid alkaline compositions contain a first surfactant that is a reverse EO/PO block copolymer of about 10-40% EO and a second surfactant that is at least one of a reverse EO/PO block copolymer of about 40-50% EO, an alkyl capped alcohol ethoxylate, a capped block copolymer, and alkyl pyrrolidone are provided. Methods of using the surfactant compositions and solid compositions are provided.

### CROSS REFERENCE TO RELATED APPLICATIONS

This application claims priority under 35 U.S.C. § 119 to provisional application Ser. No. 63/490,892, filed Mar. 17, 2023, which is herein incorporated by reference in its entirety.

### TECHNICAL FIELD

The present disclosure relates to the field of solid compositions for various applications of use having a detersive combination of surfactants. Solid compositions containing a first surfactant that is a first reverse EO/PO block copolymer of about 10-40% EO and a second surfactant that is at least one of a second reverse EO/PO block copolymer of about 40-50% EO, an alkyl capped alcohol ethoxylate, a capped block copolymer, and alkyl pyrrolidone, which are formulated in solid alkaline compositions. Beneficially, the provide optimal performance for defoaming and in some embodiments partial protein denaturation to provide efficacious compositions for use in cleaning, rinsing, sanitizing, and disinfecting.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Alkali metal hydroxides, commonly referred to as caustic, are commonly sold in solid form (e.g. pellets, flakes, blocks) and are frequently used in manufacturing processes. The manufacturing of caustic beads is energy intensive and compositions containing caustic beads are generally hygroscopic. Additionally, there are safety concerns surrounding the transportation and handling of other strong bases, such as alkoxides. Despite challenges of using solid caustic and alkoxides there remains advantages to using solid caustic compositions. For example, storing and transporting of solid concentrates are less expensive than the storage and transporting of liquids. There are also fewer safety and stability challenges associated with transporting and handling of solid compositions.

Therefore, it is an object of the disclosure to provide solid caustic compositions and methods of making the solid compositions which provide cost effective alternatives to the purchase of solid caustic to incorporate into a solid composition.

The use of alkali metal hydroxide compositions for various warewashing and other applications, such as bottle washing, pulp antifoaming applications, and others further requires the use of surfactants to tailor the cleaning capabilities of the caustic compositions. A particular challenge is providing desired defoaming or antifoaming in these compositions. Accordingly, it is an objective of the claimed disclosure to develop solid caustic compositions that provide highly effective defoaming and antifoaming surfactant packages while maintaining efficacy for soil removal.

It is further reported in literature that protein macromolecules maintain certain conformation or overall structure in its natural state which are dictated by secondary and tertiary structures. Denaturation disrupts the alpha helix and beta sheets in a protein and uncoil it into a random shape. The most common observation of the denaturation process is the precipitation and coagulation of the protein. Protein soil presents significant challenges in machine warewashing and CIP cleaning as they are difficult to remove and can produce stable foams.

Accordingly, it is an objective to develop compositions and surfactant compositions that can partially denature proteins and provide required defoaming to avoid cavitation in pumping mechanical action. It is desired to provide antifoaming or defoaming surfactant to be surface active enough to penetrate protein stabilized foam lamellae, partially denature the protein to a certain degree to produce proper defoaming, yet without full denaturation to cause precipitation/coagulation of the protein to cause deposition problem.

It is a further objective to develop solid compositions that can more universally be used for various applications due to the surfactant packages formulated with the solid caustic compositions.

It is a further object of the disclosure to provide methods for using the solid compositions containing the universal surfactant compositions that provide desired wetting, penetrating of soils, including removing protein soils, while also being defoaming and antifoaming surfactant compositions.

Other objects, advantages and features of the present disclosure will become apparent from the following specification taken in conjunction with the accompanying drawings.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

The solid compositions according to the disclosure provide solid alkaline compositions with versatile and universal surfactant compositions including a first surfactant that is a first reverse EO/PO block copolymer of about 10-40% EO and a second surfactant that is at least one of a second reverse EO/PO block copolymer of about 40-50% EO, an alkyl capped alcohol ethoxylate, a capped block copolymer, and alkyl pyrrolidone. Methods of producing the solid compositions and methods of using the solid compositions are also included in the embodiments of the disclosure.

Methods of using the solid compositions comprise generating a use solution of the solid compositions described herein, contacting an article or surface in need of defoaming or antifoaming and cleaning, rinsing, disinfecting, and/or sanitizing with the use solution; and cleaning, rinsing, disinfecting, and/or sanitizing the article or surface.

The surfactant compositions according to the disclosure provide defoaming and antifoaming surfactant compositions comprising: a reverse EO/PO block copolymer of about 10-40% EO; and at least one of an alkyl capped alcohol ethoxylate, and/or alkyl pyrrolidone; wherein the composition provides defoaming and antifoam suitable for rinse additives, bottle washing, and pulp processing, and wherein the composition is a liquid or a solid.

Methods of using the surfactant compositions comprise generating a use solution of the defoaming and antifoam surfactant compositions described herein; and contacting an article or surface in need of cleaning or rinsing, the liquid system is maintained free of foam to avoid cavitation in pumping or circulation.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a graph showing the foam height in mL of tested surfactant solutions at 80° C.

FIG. 2 is a graph showing the foam height in mL of tested surfactant solutions at 60° C.

FIG. 3 is a set of glass and plastic wares showing 10-cycle automatic dishwashing results using 1000 ppm of each detergent solution of Tables 10-16 and 2000 ppm of food soil in 5 gpg water and at 160° F.

FIG. 4 is a set of ceramic tiles showing 10-cycle automatic dishwashing results using 1000 ppm of each detergent solution of Tables 10-16 and 2000 ppm of food soil in 5 gpg water and 160° F.

FIG. 5 is a set of glasses showing results of results of 50-cycle warewash tests at 1000 ppm of the detergent solution of Table 19, and 4000 ppm food soil.

FIG. 6A is a set of glasses showing results of results of 1000-cycle warewash tests at 1000 ppm of the detergent solution of Table 19, and 17 grain water.

FIG. 6B is a set of glasses results of results of 1000-cycle warewash tests at 1000 ppm of the detergent solution of Table 21, and 17 grain water.

FIG. 7 is a graph showing the normalized drop size increase of the tested surfactants on protein-coated ceramic surface at 70° C. over 3 seconds.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The embodiments of this disclosure are not limited to particular solid compositions, methods of making and/or methods of employing the same, which can vary and are understood by skilled artisans. So that the disclosure may be more readily understood, certain terms are first defined. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, humidity, molar ratios, log count of bacteria or viruses, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkoxide” refers to a conjugate base of an organic molecule having one or more hydroxyl groups and can be formed through the deprontonation of the hydroxyl group(s), which is a weak acid/base reaction. Alkoxides can be formed through the reaction of an alkali metal hydroxide and an organic molecule having one or more hydroxyl-groups or an alkylene carbonate as disclosed in U.S. Patent Application No. ______, claiming priority to U.S. Ser. No. 63/490,838, filed simultaneously herewith and titled “Alkoxide-Based Solidification Via Control of Reaction Equilibrium and Kinetics”, which is incorporated by reference in its entirety.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “analog” means a molecular derivative of a molecule. The term is synonymous with the terms “structural analog” or “chemical analog.”

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “disinfectant” refers to an agent that kills all vegetative cells including most recognized pathogenic microorganisms, using the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). According to this reference a disinfectant should provide a 99.999% reduction (5-log order reduction) within 30 seconds at room temperature, 25±2° C., against several test organisms. According to embodiments of the disclosure, a disinfecting composition provides a 99.999% reduction (5-log order reduction) of the desired organisms (including bacterial contaminants) at a use temperature. Further, a disinfectant should provide a 99.99% reduction (4-log order reduction) within 30 seconds at room temperature, 25±2° C., against several test organisms. According to embodiments of the disclosure, a disinfecting composition provides a 99.99% reduction (4-log order reduction) of the desired organisms (including bacterial contaminants) at a use temperature. Further, a disinfectant should provide a 99.9% reduction (3-log order reduction) within 30 seconds at room temperature, 25±2° C., against several test organisms. According to embodiments of the disclosure, a disinfecting composition provides a 99.9% reduction (3-log order reduction) of the desired organisms (including bacterial contaminants) at a use temperature. As used herein, the term “high level disinfection” or “high level disinfectant” refers to a compound or composition that kills substantially all organisms, except high levels of bacterial spores, and is effected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “generally” encompasses both “about” and “substantially.”

The term “hard surface” refers to a solid, substantially non-flexible surface such as a counter top, tile, floor, wall, panel, window, plumbing fixture, kitchen and bathroom furniture, appliance, engine, circuit board, dish, minor, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “oligomer” refers to a molecular complex comprised of between one and ten monomeric units. For example, dimers, trimers, and tetramers, are considered oligomers. Furthermore, unless otherwise specifically limited, the term “oligomer” shall include all possible isomeric configurations of the molecule, including, but are not limited to isotactic, syndiotactic and random symmetries, and combinations thereof. Furthermore, unless otherwise specifically limited, the term “oligomer” shall include all possible geometrical configurations of the molecule.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “sanitizer” refers to an agent that reduces the number of bacterial contaminants to safe levels as judged by public health requirements. In an embodiment, sanitizers for use in this invention will provide at least a 99.999% reduction (5-log order reduction). These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soft surface” refers to surfaces not classified as hard surfaces, but which are solid surfaces. Soft surfaces, include, but are not limited to, textiles, fabrics, woven surfaces, and non-woven surfaces. Soft surfaces, include, but are not limited to, carpet, curtains, fabrics, hospital partitions, linens, and upholstery.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyimide.

The term “weight percent,” “wt-%,” “percent by weight,” “ % by weight,” and variations thereof, as used herein, refer to the concentration of a substance as the weight of that substance divided by the total weight of the composition and multiplied by 100. It is understood that, as used here, “percent,” “ %,” and the like are intended to be synonymous with “weight percent,” “wt-%,” etc.

The solid compositions, methods of making the compositions, and methods of use of the present disclosure may comprise, consist essentially of, or consist of the components and ingredients of the present disclosure as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Surfactant Compositions

According to embodiments, surfactant compositions can be universally employed for versatile applications of use. In embodiments the surfactant compositions can be incorporated in various cleaning compositions as described further herein. In embodiments the surfactant compositions can be formulated in liquid or solid compositions. The surfactant compositions include a first surfactant comprising a first reverse EO/PO block copolymer, preferably a reverse EO/PO block copolymer of about 10-40% EO, most preferably a reverse EO/PO block copolymer of about 20% EO, and a second surfactant comprising a second reverse EO/PO block copolymer of about 40% EO, an alkyl capped alcohol ethoxylate and/or alkyl pyrrolidone. In embodiments the surfactant compositions can include additional surfactants and/or functional ingredients.

Exemplary surfactant compositions suitable for use in liquid or solid compositions are shown in Tables 1A-1B in weight percentage. While the components may have a percent actives of 100%, it is noted that Tables 1A-1B do not recite the percent actives of the components, but rather, recites the total weight percentage of the raw materials (i.e. active concentration plus inert ingredients).

TABLE 1A

| | First | Second | Third |
|---|---|---|---|
| | Exemplary | Exemplary | Exemplary |
| | Range | Range | Range |
| Material | wt.-% | wt.-% | wt.-% |
| Reverse EO/PO block | 0.1-50 | 0.5-20 | 0.5-2 |
| copolymer | | | |
| Alkyl capped alcohol | 0.1-50 | 1-20 | 1-10 |
| ethoxylate | | | |
| Additional Functional | 0-90 | 0-75 | 0-50 |
| Ingredients and water | | | |
| carrier | | | |
| Total | 100 | 100 | 100 |

TABLE 1B

| | First | Second | Third |
|---|---|---|---|
| | Exemplary | Exemplary | Exemplary |
| | Range | Range | Range |
| Material | wt.-% | wt.-% | wt.-% |
| Reverse EO/PO block | 0.1-50 | 0.5-20 | 0.5-2 |
| copolymer | | | |
| Alkyl pyrrolidone | 0.1-50 | 1-20 | 1-10 |
| Additional Functional | 0-90 | 0-75 | 0-50 |
| Ingredients and | | | |
| solidifying agents | | | |
| Total | 100 | 100 | 100 |

### Solid Compositions

The solid compositions employing the surfactant compositions as described herein comprise an alkalinity source (e.g. hydroxide, carbonate, reagents of alkali metal hydroxide and an organic molecule having at least one hydroxyl group (e.g. polyol) or alkylene carbonate, or combinations thereof) in combination with the surfactant composition including a first surfactant comprising a first reverse EO/PO block copolymer, preferably a reverse EO/PO block copolymer of about 10-40% EO, most preferably a reverse EO/PO block copolymer of about 20% EO, for protein soil defoaming, and a second surfactant comprising at least one of a second reverse EO/PO block copolymer of about 40% EO, an alkyl capped alcohol ethoxylate, a capped block copolymer, and alkyl pyrrolidone for protein soil removal. In embodiments the solid compositions can further comprise at least one additional functional ingredient, such as a water conditioning agent, e.g. water conditioning polymer, hydrotrope and/or chelant.

Exemplary ranges of the solid compositions according to the disclosure are shown in Tables 2A-2B each in weight percentage. Exemplary ranges of the reagents to make the solid compositions are shown in Tables 2C-2D, where the simplified term “polyol” is used, however also includes the scope of the broader description contained herein of organic molecules having at least one hydroxyl group (i.e. includes polyols). While the components may have a percent actives of 100%, it is noted that Tables 2A-2D do not recite the percent actives of the components, but rather, recites the total weight percentage of the raw materials (i.e. active concentration plus inert ingredients).

TABLE 2A

| | First | Second | Third |
|---|---|---|---|
| | Exemplary | Exemplary | Exemplary |
| | Range | Range | Range |
| Material | wt.-% | wt.-% | wt.-% |
| First Surfactant | 0.1-5 | 0.5-5 | 0.5-2 |
| Second Surfactant(s) | 0.1-20 | 1-20 | 1-10 |
| Alkalinity source | 10-90 | 25-90 | 30-80 |
| Additional Functional | 0-50 | 0-30 | 0-25 |
| Ingredients | | | |
| Total | 100 | 100 | 100 |

TABLE 2B

| | First | Second | Third |
|---|---|---|---|
| | Exemplary | Exemplary | Exemplary |
| | Range | Range | Range |
| Material | wt.-% | wt.-% | wt.-% |
| First Surfactant | 0.1-5 | 0.5-5 | 0.5-2 |
| Second Surfactant(s) | 0.1-20 | 1-20 | 1-10 |
| Alkalinity source | 10-90 | 25-90 | 30-80 |
| Water Conditioning | 0-10 | 0.1-10 | 1-10 |
| Agent | | | |
| Hydrotrope | 0-10 | 0.1-10 | 1-10 |
| Chelant | 0-20 | 0.5-20 | 5-20 |
| Additional Functional | 0-50 | 0-30 | 0-25 |
| Ingredients | | | |
| Total | 100 | 100 | 100 |

TABLE 2C

| | First | Second | Third |
|---|---|---|---|
| | Exemplary | Exemplary | Exemplary |
| | Range | Range | Range |
| Material | wt.-% | wt.-% | wt.-% |
| First Surfactant | 0.1-5 | 0.5-5 | 0.5-2 |
| Second Surfactant(s) | 0.1-20 | 1-20 | 1-10 |
| Alkali metal hydroxide | 10-90 | 25-90 | 30-80 |

Polyol or Alkylene Carbonate

| | | | |
|---|---|---|---|
| Polyol | 1-20 | 1-15 | 1-10 |
| Alkylene Carbonate | 1-40 | 1-20 | 5-20 |
| Additional Functional | 0-50 | 0-30 | 0-25 |
| Ingredients | | | |
| Total | 100 | 100 | 100 |

TABLE 2D

| | First | Second | Third |
|---|---|---|---|
| | Exemplary | Exemplary | Exemplary |
| | Range | Range | Range |
| Material | wt.-% | wt.-% | wt.-% |
| First Surfactant | 0.1-5 | 0.5-5 | 0.5-2 |
| Second Surfactant(s) | 0.1-20 | 1-20 | 1-10 |
| Alkali metal hydroxide | 10-90 | 25-90 | 30-80 |

Polyol or Alkylene Carbonate

| | | | |
|---|---|---|---|
| Polyol | 1-20 | 1-15 | 1-10 |
| Alkylene Carbonate | 1-40 | 1-20 | 5-20 |
| Water Conditioning | 0-10 | 0.1-10 | 1-10 |
| Agent | | | |
| Hydrotrope | 0-10 | 0.1-10 | 1-10 |
| Chelant | 0-20 | 0.5-20 | 5-20 |
| Additional Functional | 0-50 | 0-30 | 0-25 |
| Ingredients | | | |
| Total | 100 | 100 | 100 |

### Reverse EO/PO Block Copolymer

Reverse EO/PO block copolymers can be included in the surfactant compositions and/or the solid compositions as disclosed herein. A “reverse” EO/PO block copolymer structure has EO groups on the inside and the PO groups are on the outside, (PO)_{Y}(EO)_{X}(PO)_{Y} wherein EO represents an ethylene oxide group, PO represents a propylene oxide group, and X and Y reflect the average molecular proportion of each alkylene oxide monomer in the overall block copolymer composition. The reverse EO/PO block copolymer surfactants can be linear or branched.

Typical reverse block copolymers useful as defoamers have ethoxylation up to about 20% and those useful as wetting agents have ethoxylation between about 20% and 40%. Additionally, reverse block copolymers due not usually exhibit both good wetting and defoaming properties, instead they are typically selected for one or the other based on the degree of ethoxylation.

In embodiments, the degree of ethoxylation of the first reverse EO/PO block copolymers included as a first surfactant for protein soil defoaming is about 10-40%, about 20-40%, most preferably about 20%. In embodiments of the first surfactant, the propoxylation of the first reverse EO/PO block copolymers is about 60-90%, about 60-80%, most preferably about 80%. In addition, without being limited according to the disclosure, all ranges recited are inclusive of the numbers defining the range and include each integer within the defined range. Commercially available examples of the reverse EO/PO block copolymers included as a first surfactant for protein soil defoaming include for example PLURONIC 25R2 and SURFONIC LD-097.

In a preferred embodiment the first surfactant is a reverse EO/PO block copolymer of about 20-40% EO. In a further preferred embodiment the first surfactant is a reverse EO/PO block copolymer having about 20% EO/80% PO regardless of the number of arms in the surfactant structure.

In an embodiment, the ethoxylation of the reverse EO/PO block copolymers included as a second surfactant for protein soil cleaning (i.e. removal) is about 40-50% and can have a linear or branched (i.e. arms) structure. In embodiments of the second surfactant, the propoxylation of the reverse EO/PO block copolymers is about 50-60%. In addition, without being limited according to the disclosure, all ranges recited are inclusive of the numbers defining the range and include each integer within the defined range. Commercially available examples of the EO/PO block copolymers included as a second surfactant for protein soil removal include for example TETRONIC 90R4.

In a preferred embodiment the second surfactant is a reverse EO/PO block copolymer having about 40% EO/60% PO.

According to various embodiments the reverse EO/PO block copolymer(s) included as a surfactant in the surfactant compositions for liquid or solid compositions, such as shown in Tables 1A-1B, is/are included in an amount of about 0.1 wt-% to about 50 wt-%, about 0.5 wt-% to about 20 wt-%, or about 0.5 wt-% to about 2 wt-%.

According to various embodiments of the solid compositions, the reverse EO/PO block copolymers is included as a first surfactant for protein soil defoaming in an amount of about 0.1 wt-% to about 10 wt-%, about 0.1 wt-% to about 5 wt-%, about 0.5 wt-% to about 5 wt-%, or about 0.5 wt-% to about 2 wt-%.

According to various embodiments of the solid compositions, the reverse EO/PO block copolymers is included as a second surfactant for protein soil cleaning in an amount of about 0.5 wt-% to about 15 wt-%, about 1 wt-% to about 10 wt-%, or about 2 wt-% to about 10 wt-%.

### Alkyl Capped Alcohol Ethoxylate

Alkyl capped alcohol ethoxylates can be included in the surfactant compositions and/or the solid compositions as disclosed herein. Alkyl capped alcohol ethoxylate compounds have the following structure: R₁—O—(CH₂CH₂O)ₙ—R₂ where R₁ is a linear or branched (C₁₀-C₁₈) alkyl group, R₂ is C₁-C₄, and n is an integer in the range of 1 to 100.

In preferred embodiments the alkyl capped alcohol ethoxylate is a butyl capped alcohol ethoxylate, such as for example a lauryl fatty alcohol ethoxylate butylether or coconut fatty alcohol ethoxylate butylether.

Commercially available examples of the alkyl capped alcohol ethoxylates included as a second surfactant for protein soil removal include for example surfactants sold under the tradename DEHYPON LT or GENAPOL BE-2810 and GENAPOL BE-2410.

According to various embodiments where the alkyl capped alcohol ethoxylate is included as a surfactant in the surfactant compositions for liquid or solid compositions, such as shown in Table 1A, is/are included in an amount of about 0.1 wt-% to about 50 wt-%, about 0.5 wt-% to about 20 wt-%, or about 0.5 wt-% to about 2 wt-%.

According to various embodiments of the solid compositions, the alkyl capped alcohol ethoxylate is included as a second surfactant for protein soil defoaming in an amount of about 0.1 wt-% to about 10 wt-%, about 0.1 wt-% to about 5 wt-%, about 0.5 wt-% to about 5 wt-%, or about 0.5 wt-% to about 2 wt-%.

### Alkyl Pyrrolidone

An alkyl pyrrolidone surfactant is optionally included as a second surfactant in the surfactant compositions and as one or more of the second surfactants of the solid compositions for protein soil removal as disclosed herein. Pyrrolidones are heterocyclic ketones derived from a pyrrolidone. Alkyl pyrrolidones have the general structure

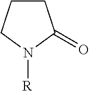

wherein R is a C6-C20 alkyl or R₁NHCOR₂, wherein R₁ is C1-C6 alkyl and R₂ is C6-C20 alkyl.

In embodiments the alkyl pyrrolidone has the general structure shown above wherein R is C8-C10 alkyl pyrrolidone. In preferred embodiments the alkyl pyrrolidone is a C8 or C10 alkyl pyrrolidone. An example of a commercially available C8 alkyl pyrrolidone (1-octyl-2-pyrrolidone) and a C12 alkyl pyrrolidone are available under the tradename SURFADONE®.

According to various embodiments the alkyl pyrrolidone if included in the surfactant compositions for liquid or solid compositions, such as shown in Table 1B, is/are included in an amount of 0.1 wt-% to about 50 wt-%, about 0.5 wt-% to about 20 wt-%, or about 0.5 wt-% to about 2 wt-%.

According to various embodiments of the solid compositions, the alkyl pyrrolidone is included as a second surfactant for protein soil cleaning in an amount of about 0.5 wt-% to about 15 wt-%, about 1 wt-% to about 10 wt-%, or about 2 wt-% to about 10 wt-%.

### Capped Block Copolymers

Capped block copolymers can be included in the surfactant compositions and/or the solid compositions as disclosed herein. Capped block copolymers are disclosed in U.S. Patent Application No. ______, claiming priority to U.S. Ser. No. 63/490,857, filed simultaneously herewith and titled “Capped Block Copolymers, Their Synthesis, Manufacture, and Methods of Use”, which is incorporated by reference in its entirety.

Preferably, the capped block copolymers are multiarmed. Preferred block copolymers may have from about 1 to about 100 moles of EO and from about 1 to about 100 moles of PO, more preferably from about 1 to about 50 moles EO and from about 1 to about 50 moles PO. Some examples of block copolymers include:

—(PO)_{Y}(EO)_{X} —(EO)_{X}(PO)_{Y} —(EO)_{X}(PO)_{Y}(EO)_{X} —(PO)_{Y}(EO)_{X}(PO)_{Y}

wherein EO represents an ethylene oxide group, PO represents a propylene oxide group, and X and Y reflect the average molecular proportion of each alkylene oxide monomer in the overall block copolymer composition. A preferred EO/PO copolymer is represented by the formula (EO)_{X}(PO)_{Y}(EO)_{X}. In another embodiment, a preferred EO/PO copolymer is represented by the formula (PO)_{Y}(EO)_{X}(PO)_{Y}. Preferably X is in the range of about 1 to about 100 and Y is in the range of about 1 to about 100. In a more preferred embodiment, X is in the range of about 5 to about 90 and Y is in the range of about 5 to about 90. Preferably, X plus Y is in the range of about 2 to about 200, more preferably about 10 to about 180, still more preferably about 15 to about 150. It should be understood that each X and Y in a molecule can be different. In a preferred embodiment, the block copolymer can have a molecular weight (Mₙ—number average mw) greater than about 200 and less than about 25,000, more preferably from about 500 to about 25,000, most preferably from about 1000 to about 20,000.

In embodiments the capped block copolymers provide the advantage of exhibiting good wetting and defoaming properties; this is highly beneficial as there is typically a trade-off in these properties such that high defoaming properties may come at the expense of wetting properties and high wetting properties may come at the expense of defoaming properties. A preferred embodiment for the capped block copolymer comprises a multiarm block copolymer comprising a polyfunctional moiety and at least 2 alkoxylated arms each of which is selected from the group consisting of —(PO)_{Y}(EO)_{X}, —(EO)_{X}(PO)_{Y}, —(EO)_{X}(PO)Y(EO)_{X}, and —(PO)_{Y}(EO)_{X}(PO)_{Y}; wherein X is about 1 to about 100, and Y is about 1 to about 100; wherein each of the alkxoylated arms comprises a terminus and is capped with a hydrophobic group at the terminus.

These EO/PO block copolymers can include a compact alcohol EO/PO surfactant where the EO and PO groups are in small block form, or random form. In other embodiments, the alkyl alkoxylate includes an ethylene oxide, a propylene oxide, a butylene oxide, a pentalene oxide, a hexylene oxide, a heptalene oxide, an octalene oxide, a nonalene oxide, a decylene oxide, and mixtures thereof. The alkyl group can be linear or branched and is preferably C₁-C₁₈, more preferably C₁₀-C₁₈; most preferably it is a branched alkyl group. Exemplary commercially available surfactants are available, for example, under the tradename PLURONIC® and PLURONIC R®, TETRONIC®, and SURFONIC®.

In a preferred embodiment, the block copolymer comprises a linear or multiarmed EO/PO structures. Most preferably, the block copolymer is a “reverse” block copolymer with the EO inside and the PO on the terminal end. Non-limiting examples are shown below:

(PO)_{Y}(EO)_{X}(PO)_{Y}

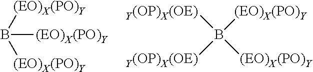

where B is an organic molecule with a polyfunctional moieties, such as a polyol, ethylene diamine, or diethylenetriamine, etc, as the starting point where the arms attach. It should be understood that these are not representative of the orientations of the arms, but merely representative of the potential formulations for purposes of illustrating the attachment of the alkoxylated arms to the starting polyfunctional moiety. Further, X and Y are defined further below where the degree of ethoxylation and propoxylation are discussed.

The capped block copolymers disclosed herein include what is often referred to as a “reverse” structure, that is, the EO groups are on the inside and the PO groups are on the outside, (PO)_{Y}(EO)_{X}(PO)_{Y}. Typical reverse block copolymers useful as defoamers have ethoxylation up to about 20% and those useful as wetting agents have ethoxylation between about 20% and 40%. However, typical reverse block copolymers for defoamer or wetting are not capped. Additionally, reverse block copolymers due not usually exhibit both good wetting and defoaming properties, instead they are typically selected for one or the other based on the degree of ethoxylation.

Preferably the ethoxylation is greater than about 20%, more preferably greater than about 20% and up to about 60%, still more preferably from about 25% to about 55%, even more preferably from about 30% to about 50%, still more preferably from about 35% to about 45%, most preferably about 40%.

Preferably the propoxylation is less than about 80%, more preferably from about 40% to less than about 80%, still more preferably from about 45% to about 75%, even more preferably from about 50% to about 70%, still more preferably from about 55% to about 65%, most preferably about 60%.

As used herein “arm(s)” refers to the alkoxylated chains; thus a multiarmed capped block copolymer would have more than one alkoxylated chain. The capped block copolymers preferably are multiarmed having at least 2 arms, more preferably at least 3 arms, even more preferably 3-6 arms, still more preferably 4 or 5 arms, and most preferred 4 arms. Preferably, the arms are formed by a branched alkyl group (backbone), which the block copolymer arms attach to. Non-limiting examples of 2 arms, 3 arms, and 4 arms are shown below for illustrative purposes:

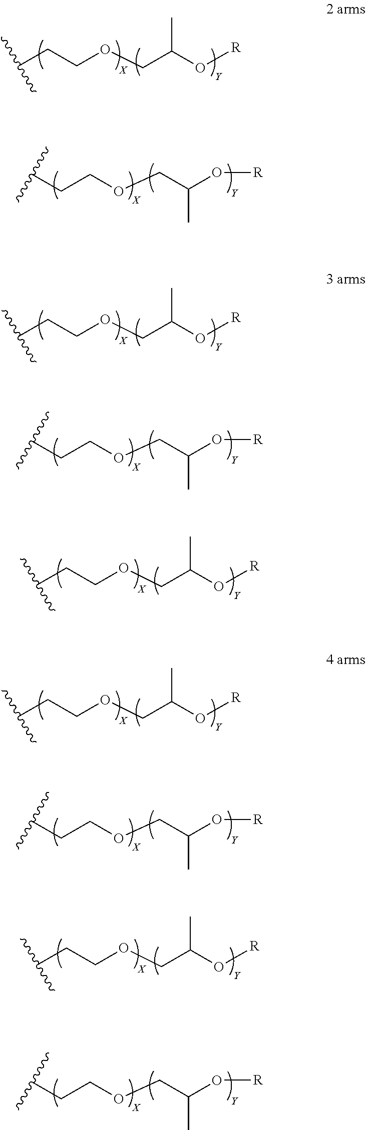

where R is a hydrophobic capping group as disclosed herein, X and Y are as defined above, each preferably between 1 and 100; and the EO/PO arms would be attached to a single backbone such that a single molecule is formed with at least 2 alkoxylated arms, at least 3 alkoxylated arms, at least 4 alkoxylated arms, at least 5 alkoxylated arms, or at least 6 alkoxylated arms. It should be understood that the block copolymer can have arms of different degrees of ethoxylation and/or propoxylation. Additionally, different arms of the block copolymer can have different hydrophobic capping groups at the terminus of each.

It should be understood that the number of arms, nature of the alkyl backbone, and percentages of ethoxylation and propoxylation on the arms can be determined by using a preexisting block copolymer surfactant and capping it according to the methods disclosed herein.

The multi-arm capped, reverse block copolymers are capped, i.e., the terminus of each arm is capped with a capping chemistry. Preferred capping chemistries are hydrophobic groups. More preferably, the hydrophobic group comprises a benzyl group and/or a substituted silyl group (R₁R₂R₃Si—) shown below:

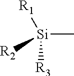

where each of R₁, R₂, and R₃ comprises an alkyl group, a phenol group, or tert-butyl.

Preferred alkyl groups for R1, R2, and/or R3 include straight-chain alkyl groups having between 1 and 10 carbons (i.e., methyl, ethyl, propyl, butyl, pentyl, hexyl, heptyl, octyl, nonyl, and decyl); cyclic alkyl groups (or “cycloalkyl” or “alicyclic” or “carbocyclic” groups), including, but not limited to, cyclopropyl, cyclopentyl, cyclohexyl, cycloheptyl, cyclooctyl, cyclononyl, and cyclodecyl; branched-chain alkyl groups, including, but not limited to isopropyl, tert-butyl, sec-butyl, isobutyl; and alkyl-substituted alkyl groups, including but not limited to, alkyl-substituted cycloalkyl groups and cycloalkyl-substituted alkyl groups.

More preferably the hydrophobic group comprises a benzyl group, trimethylsilyl (TMS), triethylsilyl (TES), tert-butyldimethylsilyl (TBS), tert-butyldiphenylsilyl (TBDPS), triisopropylsilyl (TIPS), or a combination thereof. These preferred silyl-based capping chemistries are shown below:

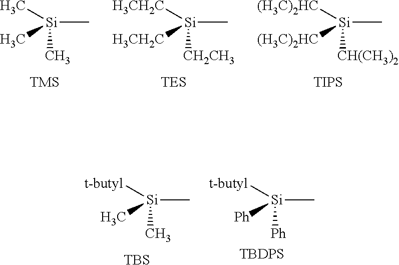

In the instance where there is a combination of hydrophobic groups utilized, this is due to capping of the different arms (e.g., two arms capped with TIPS and two arms capped with a benzyl group). Most preferably the hydrophobic group comprises a benzyl group, trimethylsilyl (TMS), triisopropylsilyl (TIPS), or a combination thereof.

In an embodiment where the block copolymer has two arms, one or both arms can be capped. In an embodiment where the block copolymer has three arms, one, two or three arms can be capped. In an embodiment where the block copolymer has four arms, one, two, three or four arms can be capped. In an embodiment where the block copolymer has five arms, one, two, three, four or five arms can be capped. In an embodiment where the block copolymer has six arms, one, two, three, four, five, or six arms can be capped.

The ratio of capped to uncapped arms can impact the thermal stability of the capped block copolymers. Thermal stability is increased with increased capping; thus, it is preferred to have a ratio of at least greater than 1:1 for capped to uncapped arms, most preferably all arms being capped for high temperature use applications. Thus, in applications requiring thermal stability it is preferable to have at least two of three arms capped, at least three of four arms capped, at least four of five arms capped, at least four of six arms capped, at least five of six arms capped, most preferably all arms capped.

Retaining some uncapped arms improves viscoelasticity of the capped block copolymers. Most preferably we found that a ratio of about 2:1 to about 4:1 capped to uncapped arms; most preferably about 3:1 capped to uncapped arms. Thus, in applications where viscoelasticity is desired, two of three arms are capped, three of four arms are capped, three of five arms are capped, four of five arms are capped, four of six arms are capped, five of six arms are capped.

Beneficially, the capped block copolymers disclosed herein have a low surface tension. Preferably a surface tension of less than about 35 dynes/cm, more preferably less than about 34 dynes/cm, still more preferably less than about 33 dynes/cm, even more preferably less than about 32 dynes/cm, yet more preferably less than about 31 dynes/cm, still more preferably less than about 30 dynes, even more preferably less than about 29 dynes, yet more preferably less than about 28 dynes/cm, still more preferably less than about 27 dynes/cm, even more preferably less than about 26 dynes/cm, yet more preferably less than about 25 dynes/cm, still more preferably less than about 24 dynes, even more preferably less than about 23 dynes, yet more preferably less than about 22 dynes/cm, still more preferably less than about 21 dynes, most preferably about 20 dynes/cm or less; when tested under ambient temperature and humidity.

As discussed above, the problems associated with proteinaceous soils are well known and particularly problematic for machine warewash and CIP cleaning. Without wishing to be bound by the theory, we believe for optimal performance, a defoaming surfactant should be surface active enough to penetrate protein stabilized foam lamellae, partially denature the protein to a certain degree to produce proper defoaming, yet without full denaturation to cause precipitation/coagulation of the protein to cause deposition problem.

According to various embodiments of the solid compositions, the capped block copolymers are included as a second surfactant in an amount of about 0.5 wt-% to about 15 wt-%, about 1 wt-% to about 10 wt-%, or about 2 wt-% to about 10 wt-%.

### Alkalinity Source

In embodiments, the solid compositions contain at least one alkalinity source. Alkalinity sources can include alkali metal hydroxides and/or alkali metal carbonates. In further embodiments, alkalinity source can be reagents combined to form an alkoxide solid, including alkali metal hydroxide and reagents comprising an organic molecule having at least one hydroxyl group or an alkylene carbonate.

Alkalinity sources can include an effective amount of one or more alkalinity sources. An effective amount of one or more alkaline sources should be considered as an amount that provides a composition having a pH between about 7 and about 14. In a particular embodiment the end-use compositions can have a pH of between about 7.5 and about 12.5.

In some embodiments the alkalinity source in the final composition is less than about 70:30 alkali metal hydroxide to water weight ratio to provide improved cleaning performance in comparison to compositions comprising additional alkali metal hydroxide.

### Alkali Metal Carbonate

In embodiments, the solid compositions contain at least one alkali metal carbonate. In an embodiment of the disclosure, any suitable source of carbonate may be used. In an embodiment, an alkali metal carbonate source may be used, for example, sodium carbonate, potassium carbonate, lithium carbonate, and combinations thereof.

The alkali metal carbonate can be in the solid compositions in an amount of about 1 wt-% to about 99.9 wt-%, about 10 wt-% to about 90 wt-%, about 20 wt-% to about 90 wt-%, about 30 wt-% to about 90 wt-%, about 30 wt-% to about 80 wt-%, about 40 wt-% to about 85 wt-%, or about 30 wt-% to about 70 wt-%.

### Alkali Metal Hydroxide

In embodiments, the solid compositions contain at least one alkali metal hydroxide as a caustic source. As referred to herein, caustic is synonymous to hydroxide. While not wishing to be bound by a particular theory or mechanism of action, it is believed that the caustic plays a role in partially denaturing proteinaceous soils to aid in their removal, and is thus particularly suitable to cleaning compositions used to clean soils comprising proteinaceous soils.

In an embodiment of the disclosure, any suitable source of caustic may be used. In an embodiment, an alkali metal caustic source may be used. For example, caustic sources may be in the form of sodium hydroxide, potassium hydroxide, lithium hydroxide, derivatives thereof, or and combinations thereof. An example of a derivative of a caustic source is a preformed alkoxide.

In the methods of making the solid composition the alkali metal hydroxide is a solution or a liquid alkali metal hydroxide. In further embodiments additional caustic source can be included in the form of a solid, such as caustic beads, pellets, flakes, powder, granules, and the like may be combined with the liquid alkali metal hydroxide.

In embodiments of the solid compositions an alkali metal hydroxide is reacted with an organic molecule having one or more hydroxyl-groups or an alkylene carbonate as disclosed in U.S. Patent Application No. ______, claiming priority to U.S. Ser. No. 63/490,838, filed simultaneously herewith and titled “Alkoxide-Based Solidification Via Control of Reaction Equilibrium and Kinetics”, which is incorporated by reference in its entirety.

In an embodiment a higher active caustic liquid is preferred for the control of equilibrium reaction and kinetics for the generation of solid compositions. In an embodiment, the molar ratio of caustic to reagent (e.g. propylene glycol) is about 1:1 to about 10:1 molar ratio, about 1:1 to about 8:1 molar ratio, about 1:1 to about 6:1 molar ratio, and preferably about 1:1. In exemplary embodiments of the Examples, the reaction of glycol reagents is faster to produce the solid compositions.

In an embodiment, a concentrated caustic can be used in the methods of making the solid. In an embodiment, 70% NaOH is preferred over a 50% NaOH to provide the 1:1 (or greater) molar ratio of caustic to reagent. In preferred embodiments, a concentrated alkali metal hydroxide comprises greater than 50% (actives basis) liquid alkali metal hydroxide. In some embodiments, the concentrated alkali metal hydroxide is from about 69% to about 74% (actives basis) liquid alkali metal hydroxide, preferably from about 70% to about 73% (actives basis) liquid alkali metal hydroxide. The concentrated alkali metal hydroxide is maintained a sufficiently high temperatures to prevent premature solidification. In an embodiment the concentrated alkali metal hydroxide is maintained, handled or otherwise processed at a temperature of at least about 66° C., or from about 66° C. to about 85° C.

In alternative embodiments the concentrated alkali metal hydroxide can include using a mixture of caustic beads and caustic liquid, wherein the methods of making the solid compositions beneficially reduce the use of caustic beads. In such an embodiment, there may still be an initial step of concentrating an alkali metal hydroxide, such as by dissolving a solid alkali metal hydroxide in a liquid alkali metal hydroxide having 50% (actives basis) or less, to provide the concentrated alkali metal hydroxide.

The alkali metal carbonate can be in the solid compositions in an amount of about 1 wt-% to about 99.9 wt-%, about 10 wt-% to about 90 wt-%, about 20 wt-% to about 90 wt-%, about 30 wt-% to about 90 wt-%, about 30 wt-% to about 80 wt-%, about 40 wt-% to about 85 wt-%, or about 30 wt-% to about 70 wt-%.

In alternative embodiments the alkali metal hydroxide can be present to make the solid compositions in an amount of about 1 wt-% to about 99.9 wt-%, about 10 wt-% to about 90 wt-%, about 20 wt-% to about 90 wt-%, about 30 wt-% to about 90 wt-%, about 30 wt-% to about 80 wt-%, or about 30 wt-% to about 70 wt-%. In other embodiments, the caustic solution includes from about 1 wt-% to about 90 wt-% of the total caustic to make the solid composition. In still other embodiments, the caustic solution includes from about 10 wt-% to about 90 wt-% of the total caustic to make the solid composition.

As described herein a liquid and a solid caustic can be combined to make the solid composition. In some embodiments where a solid caustic is employed the alkali metal hydroxide of the composition comprises less than about 40 wt-% solid caustic bead. In further embodiments where a solid caustic is employed, the composition has at least about 20% less solid caustic bead compared to a solid composition that does not contain the alkali metal hydroxide and reagent (e.g. propylene glycol).

### Polyol

The solid compositions contain at least one polyol to react with the alkali metal hydroxide to form the solid compositions. Polyols include C1-C22 alcohol, a glycol, or derivative thereof, or a combination thereof. In embodiments, a polyol is a diol, triol, and/or polyol containing more than 3 hydroxyl groups. Diol include for example, ethylene glycol, propylene glycol, hexylene glycol, tetramethylene glycol (1,4-Butanediol), etc. An exemplary triol is glycerin. An exemplary polyol is D-Sorbitol (6 hydroxyl groups).

Exemplary polyols include glycols and derivatives thereof including, ethylene glycol, propylene glycol, hexylene glycol, ethylene glycol phenyl ether, propylene glycol n-propyl ether, propylene glycol phenyl ether, dipropylene glycol n-propyl ether, and the like. Further exemplary glycerols and derivatives include, glycerol ethyl hexyl glyceryl ether, glycerin, glycerol formal, glycerol ketal, and the like. Exemplary polyols, diols and derivatives include, 3-butanediol, 1,4-butanediol, 2-ethy-1,3,-hexanediol, 1-3-propane diol, 2-methyl-2-propyl-1,3-propanediol, and the like.

A preferred polyol is glycerin. In an embodiment crude glycerin (˜85% active) is the preferred polyol. As the terms glycerin and glycerol may be used interchangeably. In addition to polyols, additional organic molecules having at least one hydroxyl group to react with the caustic source to form the solid compositions as disclosed in U.S. Patent Application No. ______, claiming priority to U.S. Ser. No. 63/490,838, filed simultaneously herewith and titled “Alkoxide-Based Solidification Via Control of Reaction Equilibrium and Kinetics”, which is incorporated by reference in its entirety.

According to various embodiments the polyol is included as a reagent to make the solid compositions in an amount of about 1 wt-% to about 30 wt-%, about 1 wt-% to about 20 wt-%, about 1 wt-% to about 15 wt-%, about 1 wt-% to about 10 wt-%, or about 2 wt--% to about 10 wt-%.

### Alkylene Carbonates

In some embodiments, the solid compositions include an alkylene carbonate to react with the caustic source to form the solid composition. Any suitable alkylene carbonate may be used.

Exemplary alkylene carbonates include for example, glycerin carbonate, ethylene carbonate, propylene carbonate, butylene carbonate, carbonate esters, and the like. A carbonate ester has a carbonyl group flanked by two alkoxy groups. In an embodiment, a cyclic organic ester is provided in the carbonate structure, such as shown for ethylene carbonate, propylene carbonate, and butylene carbonate, as follows respectively, is employed, however, any chain length of the alkyl group can be employed:

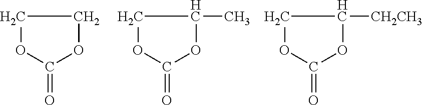

Alkylene carbonates are commercially-available (Huntsman, available under Jeffsol® tradename) and often referred to as glycol carbonates or cyclic carbonates. They are often used as reactive intermediates to replace ethylene and propylene oxides and ethylene and propylene glycols.

In embodiments the molar ratio of the initial alkali metal hydroxide to alkylene carbonate combined to make the solid composition is from about 0.5:1 to about 10:1, or from about 0:71:1 to about 9.8:1.

According to various embodiments the alkylene carbonate is included as a reagent to make the solid compositions in an amount of about 1 wt-% to about 50 wt-%, about 1 wt-% to about 40 wt-%, about 1 wt-% to about 20 wt-%, or about 5 wt-% to about 15 wt-%.

### Additional Functional Ingredients

The surfactant compositions and solid compositions may further include additional functional materials or additives that provide a beneficial property, e.g., for a particular use. Examples of conventional additives include one or more of a chelant, additional alkalinity source, additional surfactants, detersive polymer, cleaning agent, rinse aid composition, softeners, pH modifier, source of acidity, anti-corrosion agent, secondary hardening agent, solubility modifier, detergent builder, detergent filler, defoamer, anti-redeposition agent, sanitizers and/or antimicrobial agents, rinse aids, a threshold agent or system, aesthetic enhancing agent (i.e., dye, odorant, perfume), optical brightener, bleaching agent, enzyme, effervescent agent, activator for an active oxygen compound, other such additives or functional ingredients, and the like, and mixtures thereof. Adjuvants and other additive ingredients will vary according to the type of composition being manufactured, and the intended end use of the solid composition.

In some embodiments, the surfactant compositions for liquid or solid compositions and the compositions themselves are free of silicone surfactants.

In some embodiments, the surfactant compositions for liquid compositions, further include a hydrotrope, viscosity modifier, solvent, water carrier, or derivatives or combinations thereof.

In some embodiments, the surfactant compositions for liquid or solid compositions further include an additional surfactant. Additional nonionic, anionic, amphoteric and zwitterionic surfactants are disclosed, for example in U.S. Patent Application No. ______, claiming priority to U.S. Ser. No. 63/490,857, filed simultaneously herewith and titled “Capped Block Copolymers, Their Synthesis, Manufacture, and Methods of Use”, which is incorporated by reference in its entirety.

In some embodiments, the surfactant compositions for liquid or solid compositions further include a water conditioning agent. The term “water conditioning agent” refers to a compound that inhibits crystallization of water hardness ions from solution or disperses mineral scale including but not limited to calcium carbonate. Water conditioning agents can include polymeric and small molecule water conditioning agents. Organic small molecule water conditioning agents are typically organocarboxylate compounds or organophosphate water conditioning agents. Polymeric water conditioning agents commonly comprise polyanionic compositions such as polyacrylic acid compounds.

Additional examples of water conditioning polymers includes polyacrylic acid homopolymer or alkali metal salt thereof, i.e., sodium polyacrylate. The polyacrylic acid homopolymers can contains a polymerization unit derived from the monomer selected from the group consisting of acrylic acid, methacrylic acid, methyl acrylate, methyl methacrylate, ethyl acrylate, ethyl methacrylate, butyl acrylate, butyl methacrylate, iso-butyl acrylate, iso-butyl methacrylate, iso-octyl acrylate, iso-octyl methacrylate, cyclohexyl acrylate, cyclohexyl methacrylate, glycidyl acrylate, glycidyl methacrylate, hydroxyethyl acrylate, hydroxypropyl acrylate, 2-hydroxyethyl acrylate, 2-hydroxyethyl methacrylate, 2-hydroxypropyl acrylate, 2-hydroxypropyl methacrylate. and hydroxypropyl methacrylate and a mixture thereof, among which acrylic acid. methacrylic acid, methyl acrylate, methyl methacrylate, butyl acrylate, butyl methacrylate, iso-butyl acrylate, iso-butyl methacrylate, hydroxyethyl acrylate, 2-hydroxyethyl acrylate, 2-hydroxyethyl methacrylate, 2-hydroxypropyl acrylate, and 2-hydroxypropyl methacrylate, and a mixture thereof are preferred.

Preferred are polyacrylic acids, (C₃H₄O₂)ₙ or 2-Propenoic acid homopolymers; Acrylic acid polymer; Poly(acrylic acid); Propenoic acid polymer; PAA have the following structural formula:

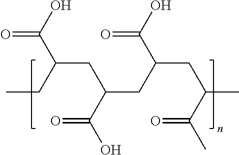

where n is any integer. One source of commercially available polyacrylates (polyacrylic acid homopolymers) includes the Acusol® 445 series from The Dow Chemical Company, Wilmington Delaware, USA, including, for example, Acusol® 445 (acrylic acid polymer, 48% total solids) (4500 MW), Acusol® 445N (sodium acrylate homopolymer, 45% total solids)(4500MW), and Acusol® 445ND (powdered sodium acrylate homopolymer, 93% total solids)(4500MW) Other polyacrylates (polyacrylic acid homopolymers) commercially available from Dow Chemical Company include, but are not limited to Acusol 929 (10,000 MW) and Acumer® 1510. Yet another example of a commercially available polyacrylic acid is AQUATREAT® AR-6 (100,000 MW) from AkzoNobel Strawinskylaan 2555 1077 ZZ Amsterdam Postbus 75730 1070 AS Amsterdam. Other suitable polyacrylates (polyacrylic acid homopolymers) include, but are not limited to those obtained from additional suppliers such as Aldrich Chemicals, Milwaukee, Wis., and ACROS Organics and Fine Chemicals, Pittsburg, Pa, BASF Corporation and SNF Inc. The homopolymers, copolymers, and/or terpolymers may be present in a composition from about 0.01 wt-% to about 30 wt-%.

Maleic anhydride/olefin copolymers are copolymers of polymaleic anhydrides and olefins. Maleic anhydride (C₂H₂(CO)₂O has the following structure:

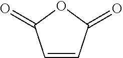

A part of the maleic anhydride can be replaced by maleimide, N-alkyl(C₁₋₄) maleimides, N-phenyl-maleimide, fumaric acid, itaconic acid, citraconic acid, aconitic acid, crotonic acid, cinnamic 10 acid, alkyl (C₁₋₁₈) esters of the foregoing acids, cycloalkyl(C₃₋₈) esters of the foregoing acids, sulfated castor oil, or the like. At least 95 wt % of the maleic anhydride polymers, copolymers, or terpolymers have a number average molecular weight of in the range between about 700 and about 20,000, preferably between about 1000 and about 100,000. A variety of linear and branched chain alpha-olefins can be used for the purposes of this disclosure. Particularly useful alpha-olefins are dienes containing 4 to 18 carbon atoms, such as butadiene, chloroprene, isoprene, and 2-methyl-1,5-hexadiene; 1-alkenes containing 4 to 8 carbon atoms, preferably C₄₋₁₀, such as isobutylene, 1-butene, 1-hexene, 1-octene, and the like.

In a preferred embodiment, particularly suitable maleic anhydride/olefin copolymers have a molecular weight between about 1000 and about 50,000, in a preferred embodiment between about 5000 and about 20,000, and in a most preferred embodiment between about 7500 and about 12,500. Examples of maleic anhydride/olefin copolymers which may be used include, but are not limited to, Acusol 460N from The Dow Chemical Company, Wilmington Delaware, USA. The maleic anhydride/olefin copolymer may be present in a composition from about 0.01 wt-% to about 30 wt-%.

Additional polymers include polycarboxylic acid polymers, include, but are not limited to, polymaleic acid homopolymers, polyacrylic acid copolymers, and maleic anhydride/olefin copolymers. Polymaleic acid (C₄H₂O₃)x or hydrolyzed polymaleic anhydride or cis-2-butenedioic acid homopolymer, has the structural formula:

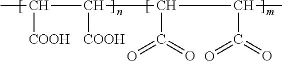

where n and m are any integer. Examples of polymaleic acid homopolymers, copolymers, and/or terpolymers (and salts thereof) which may be used are particularly preferred are those with a molecular weight of about 0 and about 5000, more preferably between about 200 and about 2000 (can you confirm these MWs). Commercially available polymaleic acid homopolymers include the Belclene 200 series of maleic acid homopolymers from BWA™ Water Additives, 979 Lakeside Parkway, Suite 925 Tucker, GA 30084, USA and Aquatreat AR-801 available from AkzoNobel. The polymaleic acid homopolymers, copolymers, and/or terpolymers may be present in a composition from about 0.01 wt-% to about 30 wt-%.

Inorganic water conditioning agents include, but are not limited to, sodium tripolyphosphate and other higher linear and cyclic polyphosphates species. Suitable condensed phosphates include sodium and potassium orthophosphate, sodium and potassium pyrophosphate, sodium tripolyphosphate, and sodium hexametaphosphate. A condensed phosphate may also assist, to a limited extent, in solidification of the solid detergent composition by fixing the free water present in the composition as water of hydration. Examples of phosphonates included, but are not limited to: 1-hydroxyethane-1,1-diphosphonic acid, CH₃C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉H₂₈₋ₓN₃NaₓO₁₅P₅ (x=7); hexamethylenediamine(tetramethylenephosphonate), potassium salt, C₁₀H₂₈₋ₓN₂KₓO₁₂P₄ (x=6); bis(hexamethylene)triamine(pentamethylenephosphonic acid), (HO₂)POCH₂N[(CH₂)₆N[CH₂PO(OH)₂]₂]₂; and phosphorus acid, H₃PO₃. A preferred phosphonate combination is ATMP and DTPMP. A neutralized or alkaline phosphonate, or a combination of the phosphonate with an alkali source before being added into the mixture such that there is little or no heat or gas generated by a neutralization reaction when the phosphonate is added is preferred.

In some embodiments, the surfactant compositions for solid compositions further include a hydrotrope, viscosity modifier, solvent, water carrier, or derivatives or combinations thereof.

In some embodiments, the solid compositions further include a chelant (also referred to as a chelating agent). Examples of chelating agents include phosphonic acid and phosphonates, phosphates, aminocarboxylates and their derivatives, pyrophosphates, ethylenediamine and ethylenetriamine derivatives, hydroxyacids, and mono-, di-, and tri-carboxylates and their corresponding acids. In certain embodiments the composition is phosphate free. Preferred chelating agents include methylglycine-N,N-diacetic acid (MGDA); glutamic acid-N,N-diacetic acid (GLDA); ethylenediaminetetraacetic acid (EDTA); diethylenetriaminepentacetic acid (DTPA); nitrilotriacetic acid (NTA); Triethylenetetramine-N,N,N′,N″,N″′,N′″-hexaacetic acid (TTHA); Aspartic acid-N,N-diacetic acid (ASDA) and alkali, alkali earth metal, transition metal and/or ammonium salts thereof. In a further embodiment a biodegradable chelating agent, such as an aminocarboxylate is preferred.

In some embodiments, the solid compositions include a chelant comprising an aminocarboxylate selected from the group consisting of MGDA, NTA, EDTA, DTPA, and TTHA. In other embodiments, the solid compositions include a chelant comprising sodium gluconate. Without being limited to a particular mechanism of action the inclusion of a chelant, namely a biodegradable aminocarboxylate, benefits by increasing the melting point of the solid formed by a caustic/polyol/chelant by further bonding with the chelant.

In some embodiments, the surfactant compositions for liquid or solid compositions further include an anti-redeposition agent, namely that is capable of facilitating sustained suspension of soils in a cleaning or rinse solution and preventing removed soils from being redeposited onto the substrate being cleaned and/or rinsed. Some examples of suitable anti-redeposition agents can include fatty acid amides, fluorocarbon surfactants, complex phosphate esters, styrene maleic anhydride copolymers, and cellulosic derivatives such as hydroxyethyl cellulose, hydroxypropyl cellulose, and the like. A composition can include up to about 10 wt-%, and in some embodiments, in the range of about 1 to about 5 wt-%, of an anti-redeposition agent.

In some embodiments, the surfactant compositions for liquid or solid compositions further include one or more functional polydimethylsiloxones. For example, in some embodiments, a polyalkylene oxide-modified polydimethylsiloxane, nonionic surfactant or a polybetaine-modified polysiloxane amphoteric surfactant can be employed as an additive. Both, in some embodiments, are linear polysiloxane copolymers to which polyethers or polybetaines have been grafted through a hydrosilation reaction. Some examples of specific siloxane surfactants are known as SILWET ® surfactants available from Union Carbide or ABIL® polyether or polybetaine polysiloxane copolymers available from Goldschmidt Chemical Corp., and described in U.S. Pat. No. 4,654,161 which patent is incorporated herein by reference. In some embodiments, the particular siloxanes used can be described as having, e.g., low surface tension, high wetting ability and excellent lubricity. For example, these surfactants are said to be among the few capable of wetting polytetrafluoroethylene surfaces. The siloxane surfactant employed as an additive can be used alone or in combination with a fluorochemical surfactant. In some embodiments, the fluorochemical surfactant employed as an additive optionally in combination with a silane, can be, for example, a nonionic fluorohydrocarbon, for example, fluorinated alkyl polyoxyethylene ethanols, fluorinated alkyl alkoxylate and fluorinated alkyl esters.

Further description of such functional polydimethylsiloxones and/or fluorochemical surfactants are described in U.S. Pat. Nos. 5,880,088; 5,880,089; and 5,603,776, all of which patents are incorporated herein by reference. We have found, for example, that the use of certain polysiloxane copolymers in a mixture with hydrocarbon surfactants provides excellent rinse aids on plastic ware. We have also found that the combination of certain silicone polysiloxane copolymers and fluorocarbon surfactants with conventional hydrocarbon surfactants also provide excellent rinse aids on plastic ware. This combination has been found to be better than the individual components except with certain polyalkylene oxide-modified polydimethylsiloxanes and polybetaine polysiloxane copolymers, where the effectiveness is about equivalent. Therefore, some embodiments encompass the polysiloxane copolymers alone and the combination with the fluorocarbon surfactant can involve polyether polysiloxanes, the nonionic siloxane surfactants. The amphoteric siloxane surfactants, the polybetaine polysiloxane copolymers may be employed alone as the additive in the end-use compositions to provide the same results.

In some embodiments, the end-use compositions may include functional polydimethylsiloxones in an amount in the range of up to about 10 wt. %. For example, some embodiments may include in the range of about 0.1 to 10 wt. % of a polyalkylene oxide-modified polydimethylsiloxane or a polybetaine-modified polysiloxane, optionally in combination with about 0.1 to 10 wt. % of a fluorinated hydrocarbon nonionic surfactant.

In some embodiments, the solid compositions further include a functional anhydrous material to absorb excess water from the mixture of hydrated solids in the composition. Examples of such a functional anhydrous material, include, but are not limited to, sodium carbonate (ash), sodium sulfate, and the like. Without being limited to a particular mechanism, the addition of a functional anhydrous material forms hydrate compounds upon contact with excess water, thus removing the excess water from the mixture.

The solid compositions refer to “solid forms” that are hardened compositions that will not flow and will substantially retain its shape under moderate stress or pressure or mere gravity. The degree of hardness of the solid cast composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the composition will remain in solid form when exposed to temperatures of up to approximately 100° F. and particularly greater than approximately 120° F.

The solid compositions may take forms including, but not limited to: a pressed solid; a cast solid product; an extruded, molded or formed solid pellet, block, tablet, powder, granule, flake; or the formed solid can thereafter be ground or formed into a powder, granule, or flake. In an exemplary embodiment, extruded pellet materials formed have a weight of between approximately 1 gram and 50 grams, or 50 grams and approximately 250 grams, extruded solids generally have a weight of approximately 100 grams or greater, and solid blocks generally have a mass of between approximately 1 and approximately 10 kilograms. The solid compositions provide for a stabilized source of functional materials.

In some embodiments, the solid composition may be dissolved, for example, in an aqueous or other medium, to create a concentrated and/or use solution. The solution may be directed to a storage reservoir for later use and/or dilution, or may be applied directly to a point of use. Alternatively, the solid alkaline composition is provided in the form of a unit dose, typically provided as a cast solid, an extruded pellet, or a tablet having a size of between approximately 1 gram and approximately 100 grams. In another alternative, multiple-use solids can be provided, such as a block or a plurality of pellets, and can be repeatedly used to generate aqueous compositions for multiple cycles.

### Methods of Use

The surfactant compositions are suitable for use in formulation various compositions, namely solid compositions. The surfactant compositions beneficially provide highly effective defoaming and antifoaming and soil removal. Various methods of using the surfactant compositions are envisioned.

In some embodiments solid warewashing compositions are provided. In other embodiments, liquid rinse aid or liquid bottle washing anti-foam additive compositions are provided. In still further embodiments, solid rinse aid or solid bottle washing anti-foam additive compositions are provided.

The methods of using the solid compositions described herein include generating a use solution of the solid composition, contacting an article or surface in need of defoaming or antifoaming and cleaning, disinfecting, and/or sanitizing with the use solution, and cleaning, disinfecting, and/or sanitizing the article or surface. The solid compositions can be referred to herein as cleaning compositions which are suitable for various applications of use.

In embodiments the pH of a use solution generated from dilution of the solid compositions is at least about 7.5, from about 7.5 to about 14, or from about 7.5 to about 12.

As referred to herein, the term ‘antifoaming’ means the surfactant composition and the compositions employing the same do not generate significant or any foam. The antifoaming prevents the generation of foam, whereas ‘defoaming’ means the surfactant composition and the compositions employing the same reduce the presence of foam.

In some embodiments, the solid composition does not slough during dispensing to generate the use solution.

In some embodiments employing the surfactant compositions, such as warewashing applications, it is a benefit of the solid compositions comprising less than about 70:30 alkali metal hydroxide to water weight ratio provide improved cleaning performance in comparison to compositions comprising additional alkali metal hydroxide. The solid compositions are less concentrated caustic compositions and therefore allow for additional performance additives, including the surfactant composition (additional functional ingredients, e.g. chelants) to improve the cleaning performance. For example, in an embodiment the solid compositions can contain less active caustic (after neutralization from acidic polymers) in the composition compared to inline solid caustic machine ware washing detergents and provide at least the same or improved cleaning efficacy.

In other embodiments, compositions employing great alkalinity are preferred, such as for example, bottle washing, rinsing and/or pulp processing. In such embodiments, solid or liquid compositions employing the surfactant compositions are preferred.

The present disclosure includes methods of using the compositions for various cleaning applications. These cleaning compositions can operate on an article, surface, in a body or stream of water or a gas, or the like, by contacting the article, surface, body, or stream with a composition of the disclosure. Contacting can include any of numerous methods for applying a cleaning composition of the disclosure, such as spraying the compositions, immersing the article in compositions, foam or gel treating the article with the compounds or composition, or a combination thereof.

It should be understood that the concentration of the ingredients in the compositions will vary depending on whether the cleaning composition is provided as a concentrate or as a use solution. A use solution may be prepared from the concentrate by diluting the concentrate with water at a dilution ratio that provides a use solution having desired detersive properties.

Exemplary industries in which the present methods can be used include, but are not limited to: food service industry; food and beverage industry; and the pharmaceutical manufacturing industry. Suitable uses for the compositions and methods of the invention may include, for example, bottle washing, machine warewashing, pulp antifoaming rinse aid, and the like.

The present methods can also be used to remove various types of soils. Such other soils include, but are not limited to, starch, cellulosic fiber, protein, simple carbohydrates and combinations of any of these soil types with mineral complexes. Examples of specific food soils that are effectively removed using the present methods include, but are not limited to, soils generated in the manufacture and processing meat, poultry, vegetables and fruit, bakery goods, soft drinks, brewing and fermentation residues, soils generated in sugar beet and cane processing and processed foods containing these ingredients and associated ingredients such as juices, sauces and condiments. These soils can develop on environmental surfaces such as walls and floors, freezers and cooling systems, heat exchange equipment surfaces, conveyor surfaces and on other surfaces during the manufacturing and packaging process.

In further embodiments, the methods of employing cleaning compositions are particularly suited for use in closed systems, e.g. dish or ware washing systems for cleaning, bottle washing systems and processes, sanitizing and/or disinfecting articles and surfaces.

The method includes contacting an article or surface with a cleaning composition or a cleaning use composition to wash the surface. The method can contact the liquid to any of a variety of surfaces or objects including surfaces or articles including those made of glass, ceramic, plastic, porcelain, aluminum, or the like.

The phrase “washing a surface with a wash solution (or a use solution or a cleaning composition)” refers to the circulation of a cleaning composition solution to remove substantially all soil from the treated surfaces (e.g. ware) and to keep that soil suspended or dissolved. In an embodiment, this step may be conducted where the temperature of the rinse water is up to about 140° F., preferably in the range of 100° F. to 140° F., preferably in the range of 110° F. to 140° F., and most preferably in the range of 120° F. to 140° F. As referred to herein, “low temperature” refers to those rinse water temperatures below about 140° F. For example, conventional rinse temperature for ware washing occurs above 140° F., such as from about 140° F. to about 190° F., particularly between about 145° F. to about 180° F. In an aspect, the methods employing a low temperature further employ a sanitizer.

Contacting can include any of numerous methods for applying a cleaning composition, such as spraying the composition, immersing the object in the composition, or a combination thereof. A concentrate or use concentration of a composition can be applied to or brought into contact with an article by any conventional method or apparatus for applying a cleaning composition to an object. For example, the object can be wiped with, sprayed with, and/or immersed in the composition, or a use solution made from the composition. The composition can be sprayed, or wiped onto a surface; the composition can be caused to flow over the surface, or the surface can be dipped into the composition. Contacting can be manual or by machine.

Before contacting an article or surface, a concentrate cleaning composition may be first diluted with water at the location of use to provide the use solution. When the composition is used in an automatic warewashing or dishwashing machine, it is expected that that the location of use will be inside the automatic warewashing machine. Depending on the machine, the composition may be provided in a unit dose form or in a multi-use form. In larger warewashing machines, a large quantity of composition may be provided in a compartment that allows for the release of a single dose amount of the composition for each wash cycle. Such a compartment may be provided as part of the warewashing machine or as a separate structure connected to the warewashing machine.

The cleaning composition may also be dispensed from a spray-type dispenser, such as that disclosed in U.S. Pat. Nos. 4,826,661, 4,690,305, 4,687,121, 4,426,362 and in U.S. Pat. Nos. Reissue 32,763 and 32,818, the disclosures of which are incorporated by reference herein. Briefly, a spray-type dispenser functions by impinging a water spray upon an exposed surface of the composition, and then immediately directing the use solution out of the dispenser to a storage reservoir or directly to a point of use. If necessary, in some embodiments, when used, the product may be removed from the packaging and inserted into the dispenser.

The methods may further employ one or more rinse steps for the treated articles or surfaces.

In some embodiments, the cleaning compositions include killing one or more of the pathogenic bacteria associated with health care surfaces and environments including, but not limited to, Salmonella typhimurium, Staphylococcus aureus, methicillin resistant Staphylococcus aureus, Salmonella choleraesurus, Pseudomonas aeruginosa, Escherichia coli, mycobacteria, yeast, and mold. The cleaning compositions have activity against a wide variety of microorganisms such as Gram positive (for example, Listeria monocytogenes or Staphylococcus aureus) and Gram negative (for example, Escherichia coli or Pseudomonas aeruginosa) bacteria, yeast, molds, bacterial spores, viruses, etc. The compounds and compositions of the present disclosure, as described above, have activity against a wide variety of human pathogens. The cleaning compositions can kill a wide variety of microorganisms on a food processing surface, on the surface of a food product, in water used for washing or processing of food product, on a health care surface, or in a health care environment.

The present methods can be used to achieve any suitable reduction of the microbial population in and/or on the target or the treated target composition. In some embodiments, the present methods can be used to reduce the microbial population in and/or on the target or the treated target composition by at least one log10. In other embodiments, the present methods can be used to reduce the microbial population in and/or on the target or the treated target composition by at least two log10. In still other embodiments, the present methods can be used to reduce the microbial population in and/or on the target or the treated target composition by at least three log10. In still other embodiments, the present methods can be used to reduce the microbial population in and/or on the target or the treated target composition by at least five log10. Without limiting the scope of disclosure, the numeric ranges are inclusive of the numbers defining the range and include each integer within the defined range.

The cleaning compositions can be used for a variety of domestic or industrial applications, e.g., to reduce microbial or viral populations on a surface or object or in a body or stream of water. The cleaning compositions can be applied in a variety of areas including kitchens, bathrooms, factories, hospitals, dental offices and food plants, and can be applied to a variety of hard or soft surfaces having smooth, irregular or porous topography. Suitable hard surfaces include, for example, architectural surfaces (e.g., floors, walls, windows, sinks, tables, counters and signs); eating utensils; hard-surface medical or surgical instruments and devices; and hard-surface packaging. Such hard surfaces can be made from a variety of materials including, for example, ceramic, metal, glass, wood or hard plastic. Suitable soft surfaces include, for example paper; filter media; hospital and surgical linens and garments; soft-surface medical or surgical instruments and devices; and soft-surface packaging. Such soft surfaces can be made from a variety of materials including, for example, paper, fiber, woven or nonwoven fabric, soft plastics and elastomers. The cleaning compositions can also be applied to soft surfaces such as food and skin (e.g., a hand). The present compounds can be employed as a non-foaming environmental sanitizer or disinfectant.

The cleaning compositions can be applied to microbes or to soiled or cleaned surfaces using a variety of methods. These methods can operate on an object, surface, in a body or stream of water or a gas, or the like, by contacting the object, surface, body, or stream with a compound of the disclosure. Contacting can include any of numerous methods for applying a compound, such as spraying the compound, immersing the object in the compound, foam or gel treating the object with the compound, or a combination thereof.

A concentrate or use concentration of a cleaning composition can be applied to or brought into contact with an object by any conventional method or apparatus for applying an antimicrobial or cleaning compound to an object. For example, the object can be wiped with, sprayed with, foamed on, and/or immersed in the compound, or a use solution made from the composition. The cleaning composition can be sprayed, foamed, or wiped onto a surface; the composition can be caused to flow over the surface, or the surface can be dipped into the cleaning composition. Contacting can be manual or by machine. Food processing surfaces, food products, food processing or transport waters, and the like can be treated with liquid, foam, gel, aerosol, gas, wax, solid, or powdered stabilized compounds according to the disclosure, or solutions containing these compounds.

Cleaning compositions of the disclosure can be formulated and sold for use as is, or as solvent or solid concentrates. If desired, such concentrates can be used full-strength as sanitizing rinse compositions. However, the concentrates typically will be diluted with a fluid (e.g., water) that subsequently forms the dilute phase or a use solution. Preferably, the concentrate forms a single phase before such dilution and remains so while stored in the container in which it will be sold. When combined with water or other desired diluting fluid at an appropriate dilution level and subjected to mild agitation (e.g., by stirring or pumping the composition), some compositions of the disclosure will form a pseudo-stable dispersion, and other compositions of the disclosure will form a clear or quasi-stable solution or dispersion. If a pseudo-stable composition is formed, then the composition preferably remains in the pseudo-stable state for a sufficiently long period so that the composition can be applied to a surface before the onset of phase separation. The pseudo-stable state need only last for a few seconds when suitably rapid application techniques such as spraying are employed, or when agitation during application is employed. The pseudo-stable state desirably lasts for at least one minute or more after mixing and while the composition is stored in a suitable vessel, and preferably lasts for five minutes or more after mixing. Often normal refilling or replenishment of the applicator (e.g., by dipping the applicator in the composition) will provide sufficient agitation to preserve the pseudo-stable state of the composition during application.

The various applications of use described herein provide the cleaning compositions to a surface and/or water source. Beneficially, the cleaning compositions of the disclosure are fast-acting. However, the present methods require a certain minimal contact time of the compositions with the surface or product in need of treatment for occurrence of sufficient antimicrobial effect. The contact time can vary with concentration of the use compositions, method of applying the use compositions, temperature of the use compositions, pH of the use compositions, amount of the surface or product to be treated, amount of soil or substrates on/in the surface or product to be treated, or the like. The contact or exposure time can be about 15 seconds, at least about 15 seconds, about 30 seconds or greater than 30 seconds. In some embodiments, the exposure time is about 1 to 5 minutes. In other embodiments, the exposure time is a few minutes to hours. In other embodiments, the exposure time is a few hours to days. The contact time will further vary based upon the use concentration of actives of compositions according to the disclosure.

All publications and patent applications in this specification are indicative of the level of ordinary skill in the art to which this disclosure pertains. All publications and patent applications are herein incorporated by reference to the same extent as if each individual publication or patent application was specifically and individually indicated as incorporated by reference.

### Embodiments

The present disclosure is further defined by the following numbered paragraphs:

1. A solid composition comprising: alkalinity source comprising an alkali metal hydroxide, alkali metal carbonate and/or reagents comprising an organic molecule having at least one hydroxyl group or an alkylene carbonate; a first surfactant comprising a first reverse EO/PO block copolymer of about 10-40% EO; and a second surfactant comprising at least one of a second reverse EO/PO block copolymer of about 40-50% EO, an alkyl capped alcohol ethoxylate, a capped block copolymer, and alkyl pyrrolidone; wherein the composition is a solid.

2. The composition of paragraph 1, wherein the first reverse EO/PO block copolymer is about 20% EO.

3. The composition of any one of paragraphs 1-2, wherein second reverse EO/PO block copolymer is about 40% EO.

4. The composition of any one of paragraphs 1-3, wherein the first surfactant comprises from about 0.1 wt-% to about 5 wt-% of the composition and wherein the second surfactant(s) comprises from about 0.1 wt-% to about 20 wt-% of the composition.

5. The composition of any one of paragraphs 1-4, wherein the second surfactant is the alkyl capped alcohol ethoxylate having the structure: R₁—O—(CH₂CH₂O)ₙ—R₂ where R₁ is a linear or branched (C₁₀-C₁₈) alkyl group, R₂ is C₁-C₄, and n is an integer in the range of 1 to 100, or preferably wherein the alkyl capped alcohol ethoxylate is a butyl capped alcohol ethoxylate.

6. The composition of any one of paragraphs 1-5, wherein the second surfactant is the alkyl pyrrolidone is C8 or C10 alkyl pyrrolidone.

7. The composition of any one of paragraphs 1-6, further comprising a chelant.

8. The composition of paragraph 7, wherein the chelant is MGDA.

9. The composition of any one of paragraphs 1-8, further comprising a hydrotrope.

10. The composition of any one of paragraphs 1-9, wherein the second surfactant comprises the alkyl capped alcohol ethoxylate and alkyl pyrrolidone.

11. The composition of any of the aforementioned paragraphs, wherein the composition has between from about 20-47%, from about 25-40% total alkalinity as measured by percentage Na₂O in the composition.

12. A method of use comprising: generating a use solution of the solid composition according to any one of paragraphs 1-11; contacting an article or surface in need of defoaming or antifoaming and cleaning, rinsing, disinfecting, and/or sanitizing with the use solution; and cleaning, rinsing, disinfecting, and/or sanitizing the article or surface.

13. The method of paragraph 12, wherein the use solution is between about 100 ppm to about 5,000 ppm, or about 500 ppm to about 2,000 ppm of the solid composition.

14. The method of any one of paragraphs 12-13, wherein the use solution is applied in a ware washing machine and optionally the use solution is contact with the articles of ware therein at a temperature range of about 120-180° F., and/or wherein the composition is effective at removing proteinaceous soils and reduces foam volume.

15. A defoaming and antifoaming surfactant composition comprising: a reverse EO/PO block copolymer of about 10-40% EO; and at least one of an alkyl capped alcohol ethoxylate and/or alkyl pyrrolidone; wherein the composition provides defoaming and antifoam suitable for rinse additives, bottle washing, and pulp processing, and wherein the composition is a liquid or a solid.

16. The composition of paragraph 16, wherein the alkyl capped alcohol ethoxylate has the structure: R₁—O—(CH₂CH₂O)ₙ—R₂ where R₁ is a linear or branched (C₁₀-C₁₈) alkyl group, R₂ is C₁-C₄, and n is an integer in the range of 1 to 100, or preferably wherein the alkyl capped alcohol ethoxylate is a butyl capped alcohol ethoxylate.

17. The composition of any one of paragraphs 15-16, wherein the alkyl pyrrolidone is C8 or C10 alkyl pyrrolidone.

18. The composition of any one of paragraphs 15-17, wherein (i) the reverse EO/PO block copolymer having 10-40% EO comprises from about 0.1 wt-% to about 50 wt-%, and wherein the alkyl capped alcohol ethoxylate comprises from about 0.1 wt-% to about 50 wt-% and/or wherein the alkyl pyrrolidone comprises from about 0.1 wt-% to about 50 wt-% of the composition, or (ii) the reverse EO/PO block copolymer having 10-40% EO comprises from about 0.5 wt-% to about 20 wt-%, and wherein the alkyl capped alcohol ethoxylate comprises from about 1 wt-% to about 20 wt-% and/or wherein the alkyl pyrrolidone comprises from about 1 wt-% to about 20 wt-% of the composition.

19. The composition of any one of paragraphs 15-18, wherein the composition is a liquid rinse aid or liquid bottle washing anti-foam additive, or wherein the composition is a solid rinse aid or solid bottle washing anti-foam additive.

20. The composition of any one of paragraphs 15-19, further comprising a hydrotrope, viscosity modifier, solvent, water carrier, and/or derivatives or combinations thereof.

21. A method of use comprising: generating a use solution of the defoaming and antifoam surfactant composition according to any one of paragraphs 15-20; and contacting an article or surface in need of cleaning or rinsing, the liquid system is maintained free of foam to avoid cavitation in pumping or circulation.

22. The method of paragraph 21, wherein the use solution is between about 50 ppm to about 5,000 ppm, about 100 ppm to about 2,000 ppm, or between about 100 ppm to about 1,000 ppm of the surfactants.

23. The method of any one of paragraphs 21-22, wherein the use solution is applied in a bottle washing cycle.

24. The method of any one of paragraphs 21-22, wherein the use solution is applied in a rinse cycle of a ware wash machine.

25. The method of any one of paragraphs 21-22, wherein the use solution is applied in a pulp processing application.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following ingredients are utilized in the Examples:
Triton DF-12—a C8-10-(PO)2(EO)11-Benzyl, commercially available from Dow Chemicals.
Dehypon LT-104L—a fatty alcohol C12-18 10 moles EO n-butyl capped, commercially available from BASF.
Dehypon LT 054—a 5 EO, n-butyl capped alcohol, commercially available from BASF.
Dehypon LS 104L—a lauryl fatty alcohol ethoxy butylether DRM, commercially available from BASF.
Genapol BE2810—a fatty alcohol C12-18 10 moles EO n-butyl capped, commercially available from Dow Chemical.
Genapol BE2410—a lauryl fatty alcohol ethoxy butylether DRM, commercially available from Dow Chemical.
Genapol EP2454—a low foaming, nonionic alkoxylated alcohol, commercially available from Dow Chemical.
Pluronic 25R2—a reverse block copolymer, 20% EO, commercially available from BASF.
Tetronic 90R4—ethylenediamine tetrakis(ethoxylate-block-propoxylate)tetrol, commercially available from BASF.
Pluronic N3—a reverse block copolymer, 1:1 blend of 20% and 40% EO, commercially available from BASF.
Novel 1012GB-21—an alcohol long chain ethoxylate sheeting agent, commercially available from Sasol.
LD 097—a polyoxypropylene polyoxyethylene reverse block copolymer, 39% EO.
Plurafac LF-221—a compact alcohol EO/PO association disruption agent, commercially available from BASF.
Plurafac LF-500—a compact alcohol EO/PO association disruption agent, commercially available from BASF.
Nalco DVS3C008—a phosphinic acid, sodium salt water conditioning agent.
Acusol 448—an acrylic acid dispersant copolymer, commercially available from Dow Chemical.
Phosphinosuccinic Oligomer (PSO), commercially available from Ecolab.
Surfadone L100—a C8 alkyl pyrrolidone, commercially available from Ashland.
Surfadone LP-100—a N-octyl-2-pyrrolidone, commercially available from Ashland.
Surfadone L300—a C12 alkyl pyrrolidone, commercially available from Ashland.
Cola Trope—a sodium salt of nonanoic acid, commercially available from Celanese.
Miranol C2M-SF (39%), commercially available Cocoamidodiproponate. -Disodium Cocoamphodipropionate, 38% with methanol.
Makon 17R2—Reverse EO/PO block copolymer from Stepan.
Makon 17R4—Reverse EO/PO block copolymer from Stepan.
Makon L61 EO/PO block copolymer from Stepan.
Makon L101—EO/PO block copolymer from Stepan.
Makon NF-5—EO/PO C8-10 linear alcohol from Stepan.
Makon NF-12—EO/PO C10-12 linear alcohol from Stepan.
Makon 4—Nonylphenol ethoxylate from Stepan.
Makon 6—Nonylphenol ethoxylate from Stepan.
Empicol IDS X50-23—Concentrated blend of nonionic surfactants and soap from Innospec.
Tegopren 5852—Low foam wetting agent from Evonik.
CLR64140—Scale-up Solid Batch composition.
EXP000929 (Batch XC9B1410)—water conditioning polymer (85% Acrylic Acid, 10% Maleic Acid, 5% ATBS) made by Ecolab.
Commercial Control detergent using a reverse EO/PO block copolymer with about 30% EO, and over 60% active caustic.
Commercially available sodium hydroxide, including caustic beads, water, linear alkyl sulfonate (LAS), sodium aluminate, sodium xylene sulfonate (SXS), glycerol carbonate, sodium carbonate, caustic bead, crude glycerin, hexylene glycol, CADA, urea, and sodium carbonate (ash).

### Example 1

Combinations of surfactants, including Dehypon LT-104L (“LT-104”), Pluronic 25R2 (“25R2”), and Pluronic N3 (“N3”), were combined with various amounts of NaOH in aqueous solutions #1-#6 as shown in Table 3, and #1-#7 as shown in Table 4. These solutions were then measured for cloud point, as shown in Tables 3 and 4.

TABLE 3

| | #1 | #2 | #3 | #4 | #5 | #6 |
|---|---|---|---|---|---|---|
| LT-104 | 0.05 | | | 0.05 | | |
| 25R2 | | 0.05 | | | 0.05 | |
| N3 | | | 0.05 | | | 0.05 |
| NaOH, 50% | 2.00 | 2.00 | 2.00 | 0.50 | 0.50 | 0.50 |
| water | 97.95 | 97.95 | 97.95 | 99.45 | 99.45 | 99.45 |
| Total | 100.00 | 100.00 | 100.00 | 100.00 | 100.00 | 100.00 |
| Cloud Pt, F° | 70 | 90 | 98 | 81 | 99 | 100 |
| Cloud Pt w/o | 84 | 102 | 108 | | | |
| NaOH, ° F. | | | | | | |

TABLE 4

| | #1 | #2 | #3 | #4 | #5 | #6 | #7 |
|---|---|---|---|---|---|---|---|
| Dehypon LT-104 | 0.05 | 0.05 | | | 0.05 | 0.05 | 0.05 |
| Pluronic 25R2 | | | 0.05 | 0.05 | 0.05 | 0.05 | 0.05 |
| NaOH, 50% | 4.00 | 1.00 | 4.00 | 1.00 | 8.00 | 2.00 | |
| DI water | 95.95 | 98.95 | 95.95 | 98.95 | 191.90 | 197.90 | 199.90 |
| Total | 100.00 | 100.00 | 100.00 | 100.00 | 200.00 | 200.00 | 200.00 |
| Cloud Pt, ° F. | 58 | 72 | 82 | 99 | 60 | 76 | 84 |

These results show the effect of sodium hydroxide (NaOH, i.e. caustic) on the evaluated surfactants. For example, as shown in the solutions of Table 3, LT-104 has the lowest cloud point at 70° F. when NaOH is at 2 wt-%, then the cloud point raises to 81° F. when the amount NaOH is lowered to 0.5 wt-% Similar results are shown for 25R2 and N3. Table 4 shows that similar effects are seen even when multiple surfactants are used, such as solutions #5-#7 illustrate.

### Example 2

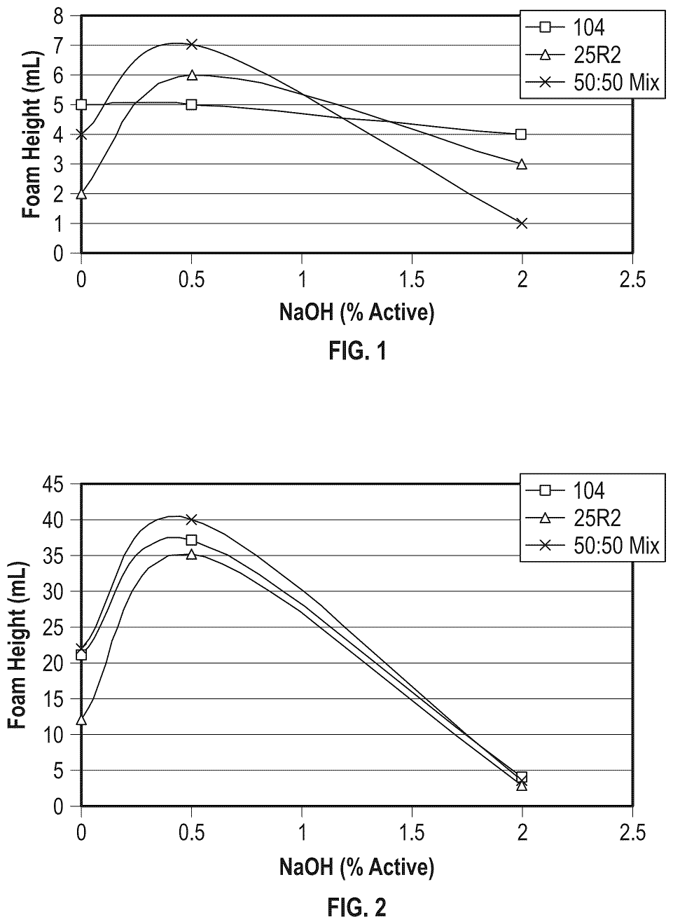

Further illustrating the cloud point results of Example 1, a graduated cylinder foam test was run (QATM 66) for solutions comprising 300 ppm of a defoamer such as Dehypon LT 104, Pluronic 25R2, or a 50:50 mixture, 300 ppm of a foamer (LAS), and various amounts of NaOH (0% active, 0.5% active, and 2% active). Table 5 and FIG. 1 illustrate the foam height (in mL) at 80° C.

TABLE 5

| | No | Dehypon | Pluronic | 50:50 |
|---|---|---|---|---|
| NaOH | defoamer | LT 104 | 25R2 | Mix |
| 0 | | 5 | 2 | 4 |
| 0.5 | 61 | 5 | 6 | 7 |
| 2 | 58 | 4 | 3 | 1 |

Table 6 and FIG. 2 illustrate the foam height at 60° C.

TABLE 6

| NaOH | | | | |
|---|---|---|---|---|
| (% | No | Dehypon LT | Pluronic | |
| active) | defoamer | 104 | 25R2 | 50:50 mix |
| 0 | | 21 | 12 | 22 |
| 0.5 | | 37 | 35 | 40 |
| 2 | 73 | 4 | 3 | 3.5 |

FIGS. 1-2 and Tables 5-6 show that the amount of NaOH impacts the foam height of the surfactant solutions at both 80° C. (FIGS. 1) and 60° C. (FIG. 2). This is a beneficial screening result that the combination of surfactants can be selected for use in antifoaming applications not only limited to machine warewashing.

### Example 3

For a rinse aid application, Glewwe Foam tests were run on surfactant packages described by Table 7 comparing commercial control formulation with packages A and B. Results from Table 8 and Table 9 show that a combination of Surfactant Packages A and B with LT-104 perform superior compared to the commercial control. These tables show that combinations of Pluronic 25R2 and Dehypon LT-104, in conjunction with other surfactants is a superior rinse aid for defoaming

TABLE 7

| | Commercial | | |
|---|---|---|---|
| | Control | | |
| | Surfactant | Surfactant | Surfactant |
| | Package | Package A | Package B |
| Surfactants | % | % | % |
| Novel 1012GB-21 | 2.66 | 2.66 | 2.66 |
| Pluronic 25R2 | 3.68 | 11.16 | 3.68 |
| Genapol EP2454 | 7.00 | 3.68 | 7.00 |
| LF-221 | 3.68 | 6.50 | 10.68 |
| LF-500 | 7.00 | N/A | N/A |

A Glewwe defoam evaluation was run with 20 g powdered milk, 3L soft water, and 50 ppm active in a Glewwe foam apparatus. The Glewwe foam apparatus was set at 6 PSI for 5 minutes at varied temperatures (° F.). The machine was then shut off and the foam was measured for 1 minute. The foam level is read after one minute of agitation and again after 5 minutes of agitation. Stable foam remains for several minutes after agitation is stopped. Partially stable foam breaks slowly within a minute. Unstable foam breaks rapidly, less the 15 seconds. The best results are unstable foam (i.e. defoaming) to no foam (antifoam).

Table 8 shows the Glewwe foam studies run on the surfactant packages of Table 7.

TABLE 8

| | Temp | after 1 min run time (inches) | | | after 5 (total) minutes run time | | |
|---|---|---|---|---|---|---|---|
| Product | (° F.) | initial | 15 sec | 1 min | initial | 15 sec | 1 min |
| Commercial Control | 140 | Trace | 0 | 0 | 2¾ | ¼ | ⅛ |
| Surfactant Package | | | | | | | |
| Commercial Control | 160 | Trace | 0 | 0 | 2¾ | ¼ | ¼ |
| Surfactant Package | | | | | | | |
| Surfactant Package A | 80 | 1½ | 6½ | 4½ | 8½ | 7½ | 6 |
| Surfactant Package A | 100 | 1½ | 1 | ½ | 1¾ | ½ | ¼ |
| Surfactant Package A | 140 | 0 | 0 | 0 | 1¼ | 0 | 0 |
| Surfactant Package A | 160 | 0 | 0 | 0 | 2 | ⅛ | ⅛ |
| Surfactant Package B | 140 | Trace | 0 | 0 | 3½ | ½ | ½ |

Table 9 shows the Glewwe foam studies run on the tested surfactants, LT-104, N3, and 25R2, alone and in combination with the surfactant packages of Table 7.

TABLE 9

| | Temp | Rinse Aid | after 1 min run time (inches) | | | after 5 (total) minutes run time | | |
|---|---|---|---|---|---|---|---|---|
| Product | (° F.) | grams used | initial | 15 sec | 1 min | initial | 15 sec | 1 min |
| LT 104 | 140 | 0.15 | 1½ | ½ | ⅛ | 3 | ¾ | ½ |
| LT 104 | 160 | 0.15 | ¾ | ⅛ | ⅛ | 4 | 1 | ½ |
| N-3 | 140 | 0.15 | 0 | 0 | 0 | 1 | 0 | 0 |
| N-3 | 160 | 0.15 | 0 | 0 | 0 | 1 | 0 | 0 |
| 25R2 | 140 | 0.15 | 0 | 0 | 0 | 0 | 0 | 0 |
| 25R2 | 160 | 0.15 | 0 | 0 | 0 | 0 | 0 | |
| LT 104/Commercial | 140 | 0.15 | 1 | ¼ | ⅛ | 2½ | ½ | ½ |
| Control (50/50 ratio) | | | | | | | | |
| LT 104/Commercial | 160 | 0.15 | Trace | 0 | 0 | 3 | ½ | ⅝ |
| Control (50/50 ratio) | | | | | | | | |
| N-3/Commercial | 140 | 0.15 | 0 | 0 | 0 | 1¼ | 0 | 0 |
| Control (50/50 ratio) | | | | | | | | |
| N-3/Commercial | 160 | 0.15 | 0 | 0 | 0 | 1¼ | 0 | 0 |
| Control (50/50 ratio) | | | | | | | | |
| 25R2/Commercial | 140 | 0.15 | 0 | 0 | 0 | 1¼ | 0 | 0 |
| Control (50/50 ratio) | | | | | | | | |
| 25R2/Commercial | 160 | 0.15 | 0 | 0 | 0 | 1¼ | 0 | 0 |
| Control (50/50 ratio) | | | | | | | | |
| LT 104/Surfactant A | 140 | 0.15 | 1 | ¼ | ¼ | 2 | ¼ | ¼ |
| (50/50 ratio) | | | | | | | | |
| LT 104/Surfactant A | 160 | 0.15 | Trace | 0 | 0 | 2½ | ½ | ¼ |
| (50/50 ratio) | | | | | | | | |
| N-3/Surfactant A | 140 | 0.15 | 0 | 0 | 0 | 1 | 0 | 0 |
| (50/50 ratio) | | | | | | | | |
| N-3/Surfactant A | 160 | 0.15 | 0 | 0 | 0 | 1 | 0 | 0 |
| (50/50 ratio) | | | | | | | | |
| 25R2/Surfactant A | 140 | 0.15 | 0 | 0 | 0 | 1 | 0 | 0 |
| (50/50 ratio) | | | | | | | | |
| 25R2/Surfactant A | 160 | 0.15 | 0 | 0 | 0 | 1 | Trace | Trace |
| (50/50 ratio) | | | | | | | | |

These results show that the combination of the tested surfactants and the surfactant packages showed little to no foam remaining after 1 minute.

### Example 4

Additional surfactants were tested in solutions as described in Tables 10-17.

TABLE 10
Formula 1

| Description | Wt. % |
|---|---|
| NaOH 50% | 30-35 |
| Nalco DVS3C008 (Phosphinic acid, sodium | 1-5 |
| salt) | |
| Acusol 448 | 5-10 |
| Sodium Aluminate | <1 |
| Pluronic 25R2 (Defoamer) | 1-5 |
| Tetronic 90R4 (Dispersant) | 1-5 |
| Sodium Xylene Sulfonate 40% | 5-10 |
| Glycerol Carbonate | 15-20 |
| Sodium Carbonate, anhyd. | 25-30 |
| Total | 100 |

TABLE 11

| Description | Wt. % |
|---|---|
| NaOH 50% | 30-35 |
| Nalco DVS3C008 (Phosphinic acid, sodium | 1-5 |
| salt) | |
| Acusol 448 | 5-10 |
| Sodium Aluminate | <1 |
| Tetronic 90R4 benzyl capped | 1-5 |
| Sodium Xylene Sulfonate 40% | 5-10 |
| Glycerol Carbonate | 15-20 |
| Sodium Carbonate, anhyd. | 25-30 |
| Total | 100 |

TABLE 12

| Description | Wt. % |
|---|---|
| NaOH 50% | 30-35 |
| Nalco DVS3C008 (Phosphinic acid, sodium | 1-5 |
| salt) | |
| Acusol 448 | 5-10 |
| Sodium Aluminate | <1 |
| Pluronic 25R2 (Defoamer) | 1-5 |
| LD 097 | 15- |
| Sodium Xylene Sulfonate 40% | 5-10 |
| Glycerol Carbonate | 15-20 |
| Sodium Carbonate, anhyd. | 25-30 |
| Total | 100 |

TABLE 13
Formula 4

| Description | Wt. % |
|---|---|
| NaOH 50% | 30-35 |
| Nalco DVS3C008 (Phosphinic acid, sodium | 1-5 |
| salt) | |
| Acusol 448 | 5-10 |
| Sodium Aluminate | <1 |
| Pluronic 25R2 (Defoamer) | 1-5 |
| PG10 C9 ester with 3 eq C9 acid, 99.17% | 1-5 |
| Sodium Xylene Sulfonate 40% | 5-10 |
| Glycerol Carbonate | 15-20 |
| Sodium Carbonate, anhyd. | 25-30 |
| Total | 100 |

TABLE 14

| Description | Wt. % |
|---|---|
| NaOH 50% | 30-35 |
| Nalco DVS3C008 (Phosphinic acid, sodium | 1-5 |
| salt) | |
| Acusol 448 | 5-10 |
| Sodium Aluminate | <1 |
| Bn-Tetronic 90R4 with 2 eq BnCl, 97.85% | 1-5 |
| Sodium Xylene Sulfonate 40% | 5-10 |
| Glycerol Carbonate | 15-20 |
| Sodium Carbonate, anhyd. | 25-30 |
| Total | 100 |

TABLE 15

| Description | Wt. % |
|---|---|
| NaOH 50% | 30-35 |
| PSO | 1-5 |
| Acusol 448 | 5-10 |
| Sodium Aluminate | <1 |
| Pluronic 25R2 (Defoamer) | 1-5 |
| Dehypon LT-104L/Genapol BE2810 | 1-5 |
| Sodium Xylene Sulfonate 40% | 5-10 |
| Glycerol Carbonate | 15-20 |
| Sodium Carbonate, anhyd. | 25-30 |
| Total | 100 |

TABLE 16

| Description | Wt. % |
|---|---|
| NaOH 50% | 30-35 |
| Nalco DVS3C008 (Phosphinic acid, sodium | 1-5 |
| salt) | |
| Acusol 448 | 5-10 |
| Sodium Aluminate | <1 |
| Pluronic 25R2 (Defoamer) | 1-5 |
| Dehypon LS 104L/Genapol BE2410 | 1-5 |
| Sodium Xylene Sulfonate 40% | 5-10 |
| Glycerol Carbonate | 15-20 |
| Sodium Carbonate, anhyd. | 25-30 |
| Total | 100 |

TABLE 17
Formula 8

| Description | Wt. % |
|---|---|
| NaOH 50% | 30-35 |
| PSO | 1-5 |
| Acusol 448 | 5-10 |
| Sodium Aluminate | <1 |
| Pluronic 25R2 (Defoamer) | 1-5 |
| PG3 C9 ester with 3 eq C9 acid, 99.10% | 1-5 |
| Sodium Xylene Sulfonate 40% | 5-10 |
| Glycerol Carbonate (Ube America) | 15-20 |
| Sodium Carbonate, anhyd. | 25-30 |
| Total | 100 |

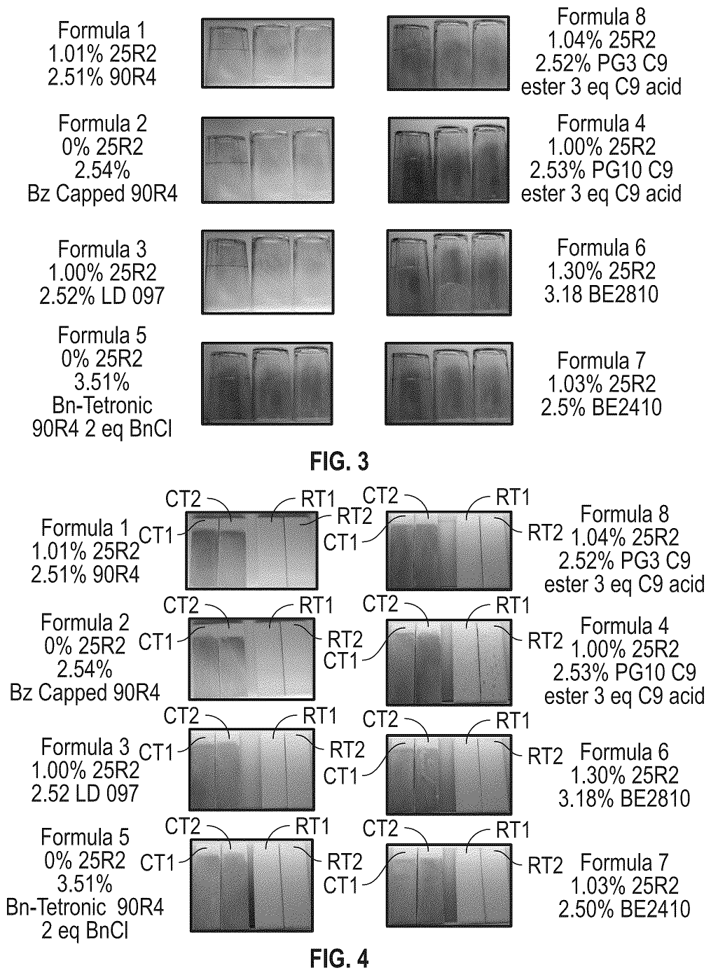

10-cycle automatic dishwashing results on both glass and plastic wares, using 1000 ppm of each detergent solution of Tables 10-17 and 2000 ppm of food soil in 5 gpg water and at 160° F. are shown in FIG. 3. FIG. 4 shows the 10-cycle automatic dishwashing results on ceramic tiles, using 1000 ppm of each detergent solution of Tables 10-17 and 2000 ppm of food soil in 5 gpg water and 160° F. These results show improved protein removal versus Formula 1 (control), evidenced by level of blue color, for Formula 2, Formula 3, Formula 5, Formula 6, and Formula 7.

Additionally, the sump and foaming from the 10-cycle automatic dishwashing of FIGS. 3 and 4 for detergent solutions of Tables 10-17 show that there was no problem with foaming in the sump after 10 cycles. Further, for Formula 6, no foam was observed on the sump wall after draining.

Reflectance readings for the detergent solutions of Tables 10-17 and FIG. 4 are based on the average differences between duplicate test ceramic tiles and duplicate unsoiled white tiles, which is shown in Table 18 below. The readings show the level of blueness which is indicative of cleaning efficacy (lower b* is better) over change in time (number of days from date stained to date b* measured).

TABLE 18

| Formula | ΔT, Days | b* |
|---|---|---|
| Inline (Control) | 544 | 6.25 |
| Formula 8 | 197 | 18.55 |
| Formula 4 | 196 | 25.95 |
| Formula 5 | 198 | 0.10 |
| Formula 6 | 189 | 17.9 |
| Formula 7 | 187 | 20.45 |

Visual inspection of freshly cleaned protein-coated ceramic plates show that the preferred surfactant combination to be 1% Pluronic 25R2 for defoaming, and 2.5% of a wetting surfactant chosen from Genapol BE-2410, Genapol BE-2810, SURFONIC LD-097, and Tetronic 90R4.

### Example 5

Additional formulations were tested with higher amounts of caustic as described in Tables 19-21.

TABLE 19
Formula 14 (liquid polymers)

| Description | Wt. % |
|---|---|
| Water | 20-25 |
| Caustic Bead | 50-55 |
| Crude Glycerin | 5-10 |
| PSO | 5-10 |
| Acusol 448 | 5-10 |
| Pluronic 25R2 | <1 |
| Sodium Aluminate | <1 |
| Hexylene Glycol | <1 |
| SURFONIC LD-097 | 1-5 |
| Sodium carbonate | 1-5 |
| | 100% |

TABLE 20
Formula 15 (liquid polymers)

| Description | Wt. % |
|---|---|
| Water | 20-25 |
| Caustic Bead | 50-55 |
| Crude Glycerin | 5-10 |
| PSO | 5-10 |
| Acusol 448 | 5-10 |
| Pluronic 25R2 | <1 |
| Sodium Aluminate | <1 |
| Hexylene Glycol | <1 |
| Genapol BE2410 | 1-5 |
| Sodium carbonate | 1-5 |
| | 100% |

TABLE 21
Formula 16 (dried polymer)

| Description | Wt. % |
|---|---|
| Water | 20-25 |
| Caustic Bead | 50-55 |
| Crude Glycerin | 5-10 |
| Dried PSO | 1-5 |
| Dried Acusol 448 | 1-5 |
| Pluronic 25R2 | <1 |
| Sodium Aluminate | <1 |
| Hexylene Glycol | <1 |
| SURFONIC LD-097 | 1-5 |
| MGDA | 8-15 |
| | 100.00% |

TABLE 22

| | Formula 14 | Formula 15 |
|---|---|---|
| | 75% Molten Caustic (72% NaOH) | 75% Molten Caustic (72% NaOH) |
| | 6% Crude Glycerin | 6% Crude Glycerin |
| Commercial Control | 2.5% SURFONIC LD-097 | 2.5% Genapol BE2410 |
| Average Blueness: −6.3 | Average Blueness: −5.6 | Average Blueness: −10.3 |

Results of 10-cycle warewash tests at 1000 ppm of each detergent solution of Tables 19-20 (Formula 14 and Formula 15), 2000 ppm food soil, and 5 grain water are shown in Table 22. The detergent solutions were compared to a Commercial Control solution. The ceramic tiles were coated with a milk and chicken soup mixture and heated for 8 minutes between cycles. Blueness was measured with a Mach5 color scanner. The more negative number means more blue color, and thus less soil removal. The Formula 14 and Formula 16 detergent solutions were repeated using the same process at 1000 ppm detergent, except with a 4-minute heating time between each cycle, and results are shown in Tables 23-24.

TABLE 23

| | Formula 1475% Molten Caustic |
|---|---|
| | (72% NaOH) |
| | 6% Crude Glycerin |
| Commercial Control | 2.5% SURFONIC LD-097 |
| Average Blueness: −19.35 | Average Blueness: −7.95 |

TABLE 24

| | Formula 1673.6% Molten Caustic |
|---|---|
| | (72% NaOH) |
| | 6% Crude Glycerin |
| | 2.5% SURFONIC LD-097 |
| Commercial Control | 10% MGDA |
| Average Blueness: −6.3 | Average Blueness: +1.3 |

As shown in Tables 23-24, Formula 14 was able to match or improve upon the protein removal of commercial control and Formula 16, which is significant since the SPS-1 solution used dry neutralized polymers, allowing room for enhancement with the MGDA chelant, significantly increased the amount of protein removal.

Results of 10-cycle warewash tests at 600 ppm of the Formula 14 and commercial control detergent solutions, 2000 ppm food soil, and 5 grain water are shown in Table 25. The ceramic tiles were coated with a milk and chicken soup mixture and heated for 8 minutes between cycles. As shown in Table 25, the commercial control outperforms the Formula 14 formula when used at low concentrations.

TABLE 25

| | Formula 14 |
|---|---|
| | 75% Molten Caustic (72% NaOH) |
| | 6% Crude Glycerin |
| Commercial Control | 2.5% SURFONIC LD-097 |
| Average Blueness: −11.7 | Average Blueness: −18.1 |

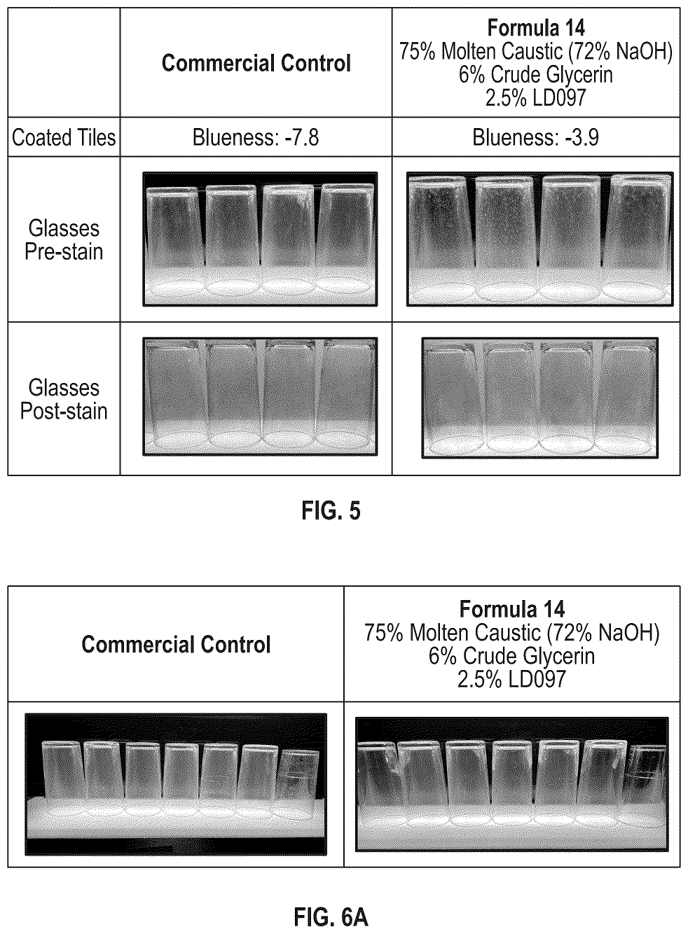

FIG. 5 shows results of 50-cycle warewash tests at 1000 ppm detergent and 4000 ppm food soil to examine redeposition on coated ceramic tiles and glasses. As shown, Formula 14 decreases the amount of redeposition on the tiles and glassware compared to the commercial control.

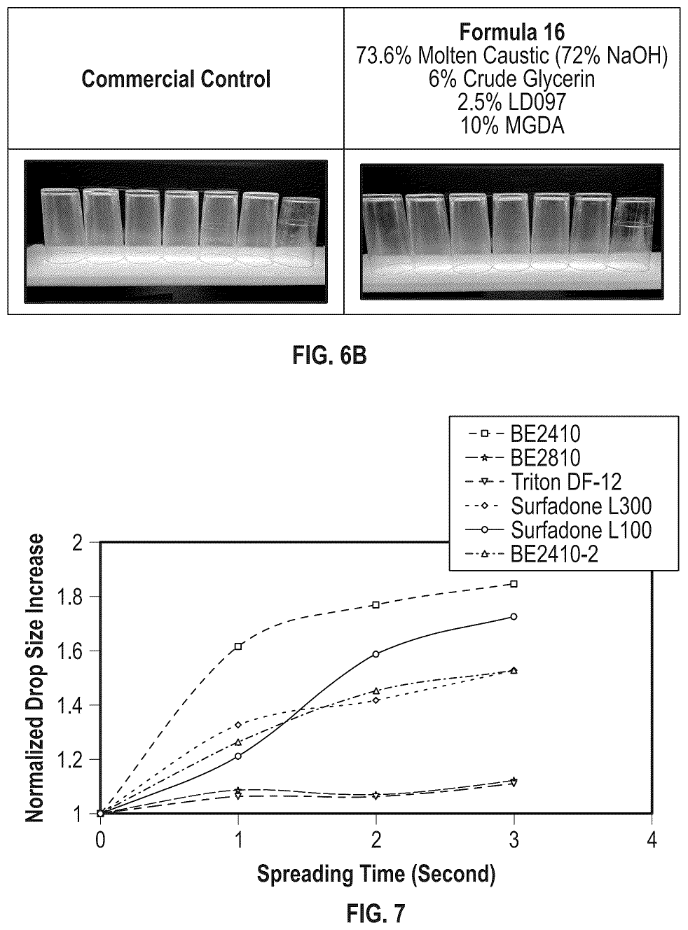

FIG. 6A shows the results of 1000 cycle warewash tests at 1000 ppm Formula 14 detergent and 17 grain water to evaluate scaling. FIG. 6B shows the results of 1000 cycle warewash tests at 1000 ppm Formula 16 detergent. Both results of Formula 14 and Formula 16 detergent solutions show matched or increased performance compared to the commercial control in scaling.

### Example 6

When adding in Surfadone L-100 or Genapol BE-2410 as wetting surfactants, phase separation could be observed in the cast solid, as a thinner and softer layer formed on top of the hard solid. To combat this, Cola Trope (sodium isononanoate) was added as a dispersant and a detergent solution, as described in Table 26, was tested for performance against the Commercial Control.

TABLE 26
Formula 17 ( liquid polymers)

| Description | Wt. % |
|---|---|
| Water | 20-25 |
| Caustic Bead | 50-55 |
| Crude Glycerin | 5-10 |
| PSO | 5-10 |
| Acusol 448 | 5-10 |
| Pluronic 25R2 | <1 |
| Sodium Aluminate 45% | <1 |
| Hexylene Glycol | <1 |
| Surfadone L-100 | 1-5 |
| Dried Colatrope | 1-5 |
| | 100.00% |

There was less phase separation observed in the cast for Formula 17. The results of a 10-cycle comparing Formula 17 to Commercial Control at 1000 ppm detergent, 2000 ppm food soil, and 5 grain water with 4-minute heating of a milk and chicken soup coating on ceramic tiles is shown in Table 27.

TABLE 27

| | Formula 17 |
|---|---|
| | 76% Molten Caustic (72% NaOH) |
| | 6% Crude Glycerin |
| | 2.5% Surfadone L-100 |
| Commercial Control | 3% Cola Trope |
| Average Blueness: −19.35 | Average Blueness: −13.925 |

As can be seen by Table 27, the added ColaTrope decreased the amount of phase separation, out-performing the Commercial Control on protein removal performance. However, results are still not as good as with SURFONIC LD-097. Thus, in the 10-cycle tests, SURFONIC LD-097 significantly out-performed Genapol BE-2410 and Surfadone L-100, which is likely because of superior self-dispersibility.

### Example 7

Wetting/spreading of droplet size of the tested surfactants was measured on protein-coated ceramic surfaces at 70° C. Droplets of capped block copolymers (Described above in listing of materials), Genapol BE2410, Triton DF 12, Surfadone LP 100, Surfadone LP 300, and Genapol BE2810 were placed on protein-coated ceramic surfaces at 70° C. The surfactants were dyed red to visualize the spreading or increased area of the droplets over a period of time. Images were taken after a period of about 3 seconds, or until the liquid stopped spreading, which was typically only a couple of second, to visually capture the spreading of the droplets. Droplets of Surfadone LP 100 and Surfadone LP 300 vastly increased their size when compared to the other tested surfactants and spread so that the dye was only barely visible and widely dispersed on the ceramic tile. Genapol BE 2810 also showed an increased droplet size, but not as much as the Surfadone surfactants.

The tested surfactants were dyed and placed on a protein-coated ceramic surface again. An image was taken of the placed droplets of surfactants. The surfactants were then immersed into water at room temperature. Tiny oily droplets were observed rising from the Genapol BE2410 and LD 097 spots while the surfactants were immersed in water. After the cleaning, another image was taken to compare to the droplets before immersion. The previous spots of Genapol BE2410 and LD 097 were whiter and did not have very much, if any, dye remaining than the spots of N3 and 25R2, a clear indication of protein removal.

FIG. 7 shows the normalized drop size increase of the tested surfactants on protein-coated ceramic surface at 70° C. over 3 seconds. This data shows that Surfadone L-100 and Genapol BE 2410 are better wetters, or increase their drop size faster, than SURFONIC LD-097.

### Example 8

Cloud point of the tested surfactants was measured as shown in Table 28, below. Cloud point is an important consideration of the effectiveness of a surfactant at a certain use temperature. Above the cloud point, a surfactant tends to coalesce into big drops and be phase separated from the aqueous phase, reducing its ability to clean oils on substrates. Most cloud points are reported in literature as 1% cloud points. However, cloud point of a surfactant varies as a function of concentration, increasing as concentration drops further from 1%. Also, as concentration drops, turbidity also drops, making cloud point measurement difficult. For the tested surfactants, a use concentration in the 20-30 ppm range was difficult to measure the cloud point measurement accurately.

TABLE 28

| | | 1% | 1% |
|---|---|---|---|
| | | Cloud | Cloud |
| | | Point | Point |
| Name | Structure | (C.) | (F.) |
| Triton DF-12 | C₈₋₁₀-(PO)₂(EO)₁₁-Benzyl | 17 | 62.6 |
| Dehypon LT-104L/ | Fatty Alcohol C12-18 10 moles EO n- | 26.5 | 79.7 |
| Genapol BE2810 | butyl capped | | |
| Dehypon LT 054 | Alcohol 5 EO, n-butyl capped | 16 | 60.8 |
| Dehypon LS 104L/ | Lauryl fatty alc ethoxy butylether DRM | 27 | 80.6 |
| Genapol BE2410 | | | |
| Surfadone L-100 | C8 alkyl pyrrolidone | N/A | N/A |
| Surfadone L-300 | C12 alkyl pyrrolidone | N/A | N/A |
| Miranol C2M_SF Conc. | Cocoamidodiproponate | N/A | N/A |
| (39%) | | | |
| Pluronic N3 | Reverse block copolymer, 1:1 blend of | 30.5 | 86.9 |
| | 20% and 40% EO | | |
| Pluronic 25-R2 | Reverse block copolymer, 20% EO | 29.5 | 85.1 |
| SURFONIC LD-097 | Reverse block copolymer, 39% EO | 43 | 109.4 |

### Example 9

The surfactant dispersibility/solubility in use solution as affected by alkalinity mix was investigated. Physical observation of use solutions comprising the tested surfactants was tested to supplement the literature cloud points. The use solutions were made according to Table 29 and Table 30 below.

TABLE 29
Formula 18

| Description | Wt. % |
|---|---|
| Water | 20-25 |
| Caustic Bead | 50-55 |
| Crude Glycerin | 5-10 |
| PSO | 5-10 |
| Acusol 448 | 5-10 |
| Pluronic 25R2 | <1 |
| Sodium Aluminate | <1 |
| Hexylene Glycol | <1 |
| SURFONIC LD-097 or | 1-5 |
| Genapol BE2410 or | |
| Surfadone L-100 | |
| Sodium carbonate | 1-5 |
| | 100% |

TABLE 30

| | Formula | Formula | Formula | Formula |
|---|---|---|---|---|
| | 1 | 19 | 20 | 21 |
| Description | Wt. % | Wt. % | Wt. % | Wt. % |
| Sodium Hydroxide | 30-35 | 30-35 | 30-35 | 30-35 |
| 50% | | | | |
| Nalco DVS3C008 | 1-5 | 1-5 | 1-5 | 1-5 |
| (Phosphinic acid, | | | | |
| sodium salt) | | | | |
| Acusol 448 | 5-10 | 5-10 | 5-10 | 5-10 |
| Sodium Aluminate | <1 | <1 | <1 | <1 |
| 45% | | | | |
| Pluronic 25R2 | 1-3 | 1-3 | 1-3 | 1-3 |
| (Defoamer) | | | | |
| Tetronic 90R4 | 1-3 | | | |
| (Dispersant) | | | | |
| LD 097 (26%, 30%; | | 1-3 | | |
| EO & PO, | | | | |
| respectively). | | | | |
| Dehypon LS 104L/ | | | 1-3 | |
| Genapol BE 2410 | | | | |
| Surfadone LP-100; | | | | 1-3 |
| N-octyl-2- | | | | |
| pyrrolidone | | | | |
| Sodium Xylene | 5-10 | 5-10 | 5-10 | 5-10 |
| Sulfonate 40% | | | | |
| Sodium Carbonate | 25-30 | 25-30 | 25-30 | 25-30 |
| Glycerol Carbonate | 12-18 | 12-18 | 12-18 | 12-18 |
| Total | 100 | 100 | 100 | 100 |

Observations were made of the solution, after the solid has been dissolved and solution thoroughly mixed via agitation, and at 2 minutes after agitation is stopped. The observed solutions were maintained at 70° C. The key observations are whether solution maintains even cloudiness, oil at the top of the solution, or clear separation out of the solution.

The formula of Table 29, containing either SURFONIC LD-097, Genapol BE2410, or Surfadone L-100, was added at 1000 ppm to 70° C. water and agitated. After 5 minutes of agitation the solution was allowed to settle and viewed if any surfactant separated out. To observe for any separation, the solution was removed from heat and allowed to settle, observing any separation that occurs. A fourth trial was ran using the Surfadone L-100 formula but adding in 25 ppm of Cola Trope (sodium isononanoate) to the solution. Four different trials were ran using different surfactants: SURFONIC LD-097, Genapol BE2410, Surfadone L-100, and Surfadone L-100 with Cola Trope.

In Trial 1, with SURFONIC LD-097 as the surfactant, minimal separation occurred. No bubbles rose to the surface, signaling that the surfactant remained evenly dispersed within the solution. In Trial 2, with Genapol BE2410 as the surfactant, small droplets formed on top of the solution, signaling that the surfactant separated out and floated to the surface. During Trial 3, with just Surfadone L-100 as the surfactant, there were similar results to Trial 2, except with more bubbles appearing on top of the solution. This suggests a large degree of separation of the surfactant occurred. Finally, in Trial 4, with Surfadone L-100 and Cola Trope, minimal separation occurred. Hardly any bubbles rose to the surface, and small bubbles could be seen evenly dispersed throughout the solution. This suggests that the hydrotrope kept the surfactant in the solution better. However, the fact that the droplets are visible to the eye indicate further modifications of hydrotrope can be made. This explains why the formula with Surfadone L-100 and Cola Trope still cannot perform as well as the formula with SURFONIC LD-097, which was perfectly dispersed in use solution.

These results show that Surfadone L-100 and Genapol BE-2410 are better at wetting on protein coated ceramic plate, as discussed in Example 7 above. The high alkalinity of the use solution of these formulations “salts them out” or renders them not soluble or dispersible in the use solution, so they are not effectively reaching the soiled substrate. On the other hand, LD097 is properly dispersed/dissolved in the use solution even under such high alkalinity and is effectively reaching the soiled substrate and do the removal. Trial 4 above also suggests that we can beneficially use a low foam hydrotrope such as isononanoate to effectively disperse Surfadone L-100 and Genapol BE-2410 in use solutions.

Observations are similar for the formulations of Table 30, except the phase separation of Surfadone L-100 and Genapol BE-2410 in the use solutions are to a lesser degree due to solid formulations having significantly lower alkalinity than those of Table 29. These observations correlate well with 10-cycle cleaning performance data. Since the alkalinity is significantly lower in the solid formulations of Table 30, the surfactants are less salted out. Sodium xylene sulfonate in these compositions also offers some hydrotroping. Under these conditions, Genapol BE-2410 and Genapol 2810 perform as well as, or even slightly better than, SURFONIC LD-097.

### Example 10

Powdered milk was evaluated by comparing the foam behavior alone and under different alkalinity and detergent conditions. The powdered milk was at 6700 ppm and combined with detergents at 1000 ppm. The powdered milk and powdered milk/detergent solutions were evaluated at 140 to 146° F. and 6 psi. The resulting foam was measured for height in inches at 30 second time increments, as illustrated in Table 31. The example capped block copolymer, Bn-Tetronic 90R4, was also evaluated under the same circumstances and is bolded in the table shown in Table 31.

TABLE 31

| | Concentrations, ppm | | Foam Heights, Inches at different times. | | | | |
|---|---|---|---|---|---|---|---|
| | | Milk | 0 | 30 | 60 | 90 | 120 |
| Chemistry | Surfactant | Protein | secs. | secs. | sec. | sec. | sec. |
| Pwd. Milk | None | 6677 | 11 | 11 | 10 | 11 | 11 |
| Pwd. Milk | None | 6700 | 11 | 10 | 9 | 9 | 9 |
| Ash (anhy.) | 1007 | 6733 | 9 | 9 | 8 | 8 | 8 |
| NaOH | 1005 | 6700 | 8.75 | 8.50 | 8.50 | 8.25 | 4.75 |
| NaOH (50%) & Ash | 1012 | 6670 | 8.50 | 8.25 | 7.75 | 7.75 | 6.75 |
| (50%) | | | | | | | |
| CLR64140 | 1003 | 6623 | 7 | 1 | 0.0 | 0.0 | 0.0 |
| Formula 22 (see | 1030 | 6703 | 0.5 | 0.0 | 0.0 | 0.0 | 0.0 |
| Table 32) | | | | | | | |
| (Formula 6) | 1003 | 6753 | 8.0 | 4.0 | 0.0 | 0.0 | 0.0 |
| Prior caustic bead | | | | | | | |
| replacement formula | | | | | | | |
| Commercial control | 1000 | 6773 | 3.5 | 0.0 | 0.0 | 0.0 | 0.0 |
| alkaline detergent 1 | | | | | | | |
| Commercial control | 1010 | 6747 | 1.8 | 0.0 | 0.0 | 0.0 | 0.0 |
| alkaline detergent 2 | | | | | | | |
| NaOH 50% (21%) | 153 | 6583 | 8.5 | 8.5 | 7.5 | 6.0 | 6.0 |
| Ash, anhy. (79%) | 1170 | | | | | | |
| NaOH (38%) | 13 | 6713 | 10.0 | 10.0 | 10.0 | 10.0 | 10.0 |
| Pluronic 25R2 | 20 | 6660 | 0.0 | 0.0 | 0.0 | 0.0 | 0.0 |
| Tetronic 90R4 | 62 | 6687 | 1.0 | 0.0 | 0.0 | 0.0 | 0.0 |
| Bn-Tetronic 90R4 | 30 | 6677 | 0.0 | 0.0 | 0.0 | 0.0 | 0.0 |
| formula | | | | | | | |
| Makon 17R2 | 14 | 6573 | 0.0 | 0.0 | 0.0 | 0.0 | 0.0 |
| Makon 17R4 | 13 | 6600 | 0.0 | 0.0 | 0.0 | 0.0 | |
| Tetronic 90R4 | 157 | 6680 | 0.0 | 0.0 | 0.0 | 0.0 | 0.0 |
| Pluronic 25R2 | 53 | | | | | | |
| MAKON L61 | 30 | 6677 | 3.0 | 0.0 | 0.0 | 0.0 | 0.0 |
| Empicol IDS X50-23 | 33 | 6637 | 11.0 | 11.0 | 11.0 | 11.0 | 11.0 |
| MAKON UD-5 | 33 | 6637 | 9.0 | 9.0 | 9.0 | 9.0 | 9.0 |
| Urea | 31 | 6727 | 10.0 | 10.0 | 10.0 | 10.0 | 10.0 |
| Tetronic 90R4 | 30 | 6670 | 1.5 | 1.5 | 0.5 | 0.0 | 0.0 |
| Tetronic 90R4 | 13 | 6747 | 0.0 | 0.0 | 0.0 | 0.0 | 0.0 |
| Pluronic 25R2 | 10 | | | | | | |
| MAKON L101 | 30 | 6653 | 5.0 | 4.8 | 4.5 | 4.5 | 4.5 |
| NaOH 50% | 508 | 6673 | 8.5 | 8.5 | 8.5 | 8.3 | 8.0 |
| Urea | 61 | | | | | | |
| NaOH 50% | 1002 | 6637 | 8.5 | 8.5 | 8.5 | 8.5 | 8.0 |
| Urea | 62 | | | | | | |
| 170205 (Lauryl Alc | 30 | 6653 | 3.0 | 1.0 | 0.3 | 0.0 | 0.0 |
| 3EO/6PO)/Dehypon LS- | | | | | | | |
| 36/Surfonic LF-42 | | | | | | | |
| Cholesterol | 30 | 6653 | 9.0 | 9.0 | 9.0 | 8.8 | 8.5 |
| Amphosol 2C (CADA) | 31 | 6643 | 8.5 | 8.5 | 8.3 | 8.3 | 8.0 |
| NaOH 50% | 1013 | | | | | | |
| 177022 | 506 | 6673 | 8.5 | 8.5 | 8.5 | 8.3 | 8.0 |
| NaOH 50% | 30 | | | | | | |
| Tegopren 5852 | 31 | 6673 | 10.0 | 10.0 | 9.5 | 9.5 | 9.0 |
| MAKON NF-5 | 30 | 6673 | 8.0 | 6.5 | 5.0 | 3.0 | 2.0 |
| MAKON NF-12 | 30 | 6693 | 3.5 | 0.5 | 0.0 | 0.0 | 0.0 |
| MAKON 4 | 30 | 6643 | 8.5 | 6.3 | 5.5 | 3.5 | 2.5 |
| MAKON 6 | 30 | 6743 | 11.0 | 11.0 | 10.0 | 10.0 | 10.0 |
| Amphosol 2C (CADA) | 31 | 6677 | 8.5 | 8.5 | 8.0 | 7.5 | 7.0 |

TABLE 32
Formula 22

| Description | Wgt., % |
|---|---|
| Sodium Hydroxide 50% | 20-25 |
| Nalco DVS3C008 (Phosphinic acid, sodium salt) | 1-5 |
| EXP000929 (Batch XC9B1410) | 10-15 |
| Ter polymer, 85% Acrylic Acid/10% Maleic | |
| Anhydride/5% 2-Acrylamido-2-Methylpropane | |
| Sulfonic Acid - ATBS) | |
| Sodium Aluminate 45% | <1 |
| Pluronic 25-R-2 | 1-5 |
| Soft Water | 1-5 |
| Tetronix 90R4 | 1-5 |
| Sodium Xylene Sulfonate 96% | 1-5 |
| Glycerol Carbonate | 5-10 |
| Sodium Carbonate | 45-50 |
| Esperase 6.0T | 1-3 |
| | 100.00 |

As seen by the results of the evaluation, the powdered milk proteins rehydrate and retain natural conformation to stabilize foam. The caustic detergents, when they are at 1000 ppm, partially denature the powdered milk protein to a higher degree than the ash, causing lower and more unstable foam. This is understandable from an ionic strength standpoint, as hydroxide anion has a higher activity coefficient than carbonate anion, and NaOH has a much lower molecular weight than sodium carbonate. Thus, the data provided in this example confirms that per weight, caustic is a much stronger denaturant than ash.

The data further confirms that, as far as defoaming free protein, reverse block copolymers (where PO blocks are at the terminus) are more effective than “regular” block copolymers (where EO blocks are near the alkyl backbone). The results of the evaluation indicate that thee defoaming properties of the surfactants are dictated by the balance of PO vs. EO, and that reverse block copolymers of 10-20% EO (thus 90-80% PO) are the most effective defoamers of protein soils. Although, the results also indicate that the number of arms of block copolymers do not appear to be an important factor for defoaming of free protein. For example, Pluronic 25R2, a linear (2-armed) reverse block copolymer with 20% EO and 80% PO, is a significantly better defoamer of free protein than Tetronic 90R4, a four-armed reverse block copolymer of 40% EO and 60% PO.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A solid composition comprising:
alkalinity source comprising an alkali metal hydroxide, alkali metal carbonate and/or reagents comprising an organic molecule having at least one hydroxyl group or an alkylene carbonate;
a first surfactant comprising a first reverse EO/PO block copolymer of about 10-40% EO; and
a second surfactant comprising at least one of a second reverse EO/PO block copolymer of about 40-50% EO, an alkyl capped alcohol ethoxylate, a capped block copolymer, and alkyl pyrrolidone;
wherein the composition is a solid.

2. The composition of claim 1, wherein the first reverse EO/PO block copolymer is about 20% EO.

3. The composition of claim 1, wherein second reverse EO/PO block copolymer is about 40% EO.

4. The composition of claim 1, wherein the first surfactant comprises from about 0.1 wt-% to about 5 wt-% of the composition and wherein the second surfactant(s) comprises from about 0.1 wt-% to about 20 wt-% of the composition.

5. The composition of claim 1, wherein the second surfactant is the alkyl capped alcohol ethoxylate having the structure: R₁—O—(CH₂CH₂O)ₙ—R₂ where R₁ is a linear or branched (C₁₀-C₁₈) alkyl group, R₂ is C₁-C₄, and n is an integer in the range of 1 to 100, or preferably wherein the alkyl capped alcohol ethoxylate is a butyl capped alcohol ethoxylate.

6. The composition of claim 1, wherein the second surfactant is the alkyl pyrrolidone is C8 or C10 alkyl pyrrolidone.

7. The composition of claim 1, further comprising a chelant.

8. The composition of claim 1, further comprising a hydrotrope.

9. The composition of claim 1, wherein the second surfactant comprises the alkyl capped alcohol ethoxylate and alkyl pyrrolidone.

10. A method of use comprising:
generating a use solution of the solid composition according to claim 1;
contacting an article or surface in need of defoaming or antifoaming and cleaning, rinsing, disinfecting, and/or sanitizing with the use solution; and
cleaning, rinsing, disinfecting, and/or sanitizing the article or surface.

11. The method of claim 10, wherein the use solution is between about 100 ppm to about 5,000 ppm, or about 500 ppm to about 2,000 ppm of the solid composition.

12. The method of claim 10, wherein the use solution is applied in a ware washing machine and optionally the use solution is contact with the articles of ware therein at a temperature range of about 120-180° F., and/or wherein the composition is effective at removing proteinaceous soils and reduces foam volume.

13. A defoaming and antifoaming surfactant composition comprising:
a reverse EO/PO block copolymer of about 10-40% EO; and
at least one of an alkyl capped alcohol ethoxylate and/or alkyl pyrrolidone;
wherein the composition provides defoaming and antifoam suitable for rinse additives, bottle washing, and pulp processing, and
wherein the composition is a liquid or a solid.

14. The composition of claim 13, wherein the alkyl capped alcohol ethoxylate has the structure: R₁—O—(CH₂CH₂O)ₙ—R₂ where R₁ is a linear or branched (C₁₀-C₁₈) alkyl group, R₂ is C₁-C₄, and n is an integer in the range of 1 to 100, or preferably wherein the alkyl capped alcohol ethoxylate is a butyl capped alcohol ethoxylate.

15. The composition of claim 13, wherein the alkyl pyrrolidone is C8 or C10 alkyl pyrrolidone.

16. The composition of claim 13, wherein (i) the reverse EO/PO block copolymer having 10-40% EO comprises from about 0.1 wt-% to about 50 wt-%, and wherein the alkyl capped alcohol ethoxylate comprises from about 0.1 wt-% to about 50 wt-% and/or wherein the alkyl pyrrolidone comprises from about 0.1 wt-% to about 50 wt-% of the composition, or (ii) the reverse EO/PO block copolymer having 10-40% EO comprises from about 0.5 wt-% to about 20 wt-%, and wherein the alkyl capped alcohol ethoxylate comprises from about 1 wt-% to about 20 wt-% and/or wherein the alkyl pyrrolidone comprises from about 1 wt-% to about 20 wt-% of the composition.

17. The composition of claim 13, wherein the composition is a liquid rinse aid or liquid bottle washing anti-foam additive, or wherein the composition is a solid rinse aid or solid bottle washing anti-foam additive.

18. The composition of claim 13, further comprising a hydrotrope, viscosity modifier, solvent, water carrier, and/or derivatives or combinations thereof.

19. A method of use comprising:
generating a use solution of the defoaming and antifoam surfactant composition according to claim 13; and
contacting an article or surface in need of cleaning or rinsing, the liquid system is maintained free of foam to avoid cavitation in pumping or circulation.

20. The method of claim 19, wherein the use solution is between about 50 ppm to about 5,000 ppm of the surfactants, and/or wherein the use solution is applied in a bottle washing cycle, applied in a rinse cycle of a ware wash machine, or applied in a pulp processing application.
